(19) United States
(12) Patent Application Publication
(10) Pub. No.: US 2026/0303669 A1
(43) Pub. Date: Oct. 1, 2026

(54) AUTOMATED MIGRATION OF SECURITY DETECTION RULES ACROSS SECURITY ANALYTICS PLATFORMS

(71) Applicant: ELASTIC TECHNOLOGIES (US) INC., WILMINGTON, DE (US)

(72) Inventors: SERGI MASSANEDA DONADEU, GIRONA (ES); MARIUS IVERSEN, VELLINGE (NO); IEVGEN SOROKOPUD, ZURICH (CH); BOJANA JAMBORCIC, BARCELONA (ES); JAMES SPITERI, PARKER, CO (US); CHARLES R. DAVISON, MARYVILLE, TN (US)

(21) Appl. No.: 19/633,416

(22) Filed: Mar. 30, 2026

Related U.S. Application Data
(60) Provisional application No. 63/780,392, filed on Mar. 30, 2025.

(51) Int. Cl. H04L 9/40

(52) U.S. Cl. CPC H04L 63/20

(57) ABSTRACT

In a particular embodiment, a computer-implemented method of migrating security detection rules from a source platform to a target platform is disclosed that includes receiving a plurality of exported rules from the source platform and for an exported rule of the plurality of exported rules, determining, using a machine learning model, whether a prebuilt rule of the target platform corresponds to the exported rule. In response to determining that the prebuilt rule corresponds to the exported rule, the method includes mapping the exported rule to the prebuilt rule. In response to determining that no prebuilt rule of the target platform corresponds to the exported rule, the method includes translating the exported rule for use in the target platform.

### FIELD OF THE TECHNOLOGY

The present disclosure relates generally to data migration and security analytics, including migration of security detection content from one security platform to another security platform.

### BACKGROUND

Security platforms such as security information and event management (SIEM) systems are used to ingest security-relevant data, normalize the data, and apply detection rules to identify events of interest. Over time, organizations may seek to migrate from a source security platform to a target security platform for any of a variety of reasons, such as consolidation of tools, adoption of new analytics capabilities, cost reduction, or replacement of legacy systems.

Migration of security detection content between platforms can be difficult and time-consuming. Detection rules developed for a source platform often rely on source-specific query languages, data models, field names, integrations, macros, lookups, and other custom elements that are not directly compatible with a target platform. As a result, rules exported from the source platform may require substantial manual review and modification before they can be used in the target platform.

In some conventional migration approaches, personnel manually review exported rules from the source platform to determine whether an existing rule of the target platform can be used in place of an exported rule. Where no such rule is available, personnel may manually translate queries, rewrite rule logic, map source data fields to target data fields, and identify data integrations needed to support operation of the translated rule in the target platform. These activities may require significant expertise in both the source platform and the target platform and may consume substantial time and resources.

Difficulties in migration may be increased where exported rules reference macros, lookups, or other custom elements. Such custom elements may be needed to understand the full logic of a rule and, if not properly accounted for, may hinder translation of the rule for use in the target platform. In addition, even where a rule can be translated, the translated rule may depend on a corresponding integration of the target platform for ingesting or normalizing data needed by the rule. Identifying whether such a corresponding integration exists may itself require additional manual investigation.

Accordingly, there remains a need for improved approaches for migrating security detection rules from a source platform to a target platform.

### SUMMARY

The following summary is provided to assist a person of ordinary skill in the art in understanding certain example aspects and combinations of features disclosed herein. The summary is not intended to describe every disclosed embodiment or every implementation and is not intended to limit the scope of any pending or future claims.

Embodiments of the present disclosure relate to technology for accelerating migration of security detection content from a source security platform to a target security platform. In some examples, exported security rules from the source platform are analyzed using a machine learning model to determine whether a prebuilt rule of the target platform corresponds to an exported rule and, when no corresponding prebuilt rule is identified, the exported rule is translated for use in the target platform. In some implementations, the translation process includes expanding macros or lookups referenced in a source query, translating the source query from a source query language to a target query language, validating and correcting syntax of the translated query, and converting source data model elements to corresponding target data model elements. The disclosed technology can also determine whether a prebuilt integration of the target platform corresponds to an exported rule and indicate whether a corresponding prebuilt integration is available or missing. By converting source-platform detection content into platform-compatible detection content for the target platform, the disclosed technology improves interoperability between heterogeneous security platforms and supports migration and deployment of security detection content using target-platform query syntax, target-platform integrations, and a target-platform data model.

In a particular embodiment, a computer-implemented method of migrating security detection rules from a source platform to a target platform is disclosed that includes receiving a plurality of exported rules from the source platform and for an exported rule of the plurality of exported rules, determining, using a machine learning model, whether a prebuilt rule of the target platform corresponds to the exported rule. In response to determining that the prebuilt rule corresponds to the exported rule, the method includes mapping the exported rule to the prebuilt rule. In response to determining that no prebuilt rule of the target platform corresponds to the exported rule, the method includes translating the exported rule for use in the target platform.

In another embodiment, a computer-implemented method of translating an exported security rule from a source platform for use in a target platform is disclosed that includes receiving the exported security rule. The method also includes translating, using a machine learning model, a query from the exported security rule from a source query language to a target query language. In addition, the method also includes validating syntax of the translated query and in response to detecting a syntax error, causing the machine learning model to correct the translated query. The method also includes converting, based on the translated query, the exported security rule from a source data model to a target data model. In addition, the method includes outputting, for installation in the target platform, a translated rule including the translated query and the target data model.

In another embodiment, a computer-implemented method of onboarding data for migration from a source security platform to a target security platform is disclosed that includes receiving a plurality of exported rules from the source security platform and for an exported rule of the plurality of exported rules, identifying, using a machine learning model, whether a prebuilt integration of the target security platform corresponds to the exported rule. The method also includes in response to identifying that the prebuilt integration corresponds to the exported rule, associating the exported rule with the prebuilt integration. In response to failing to identify a prebuilt integration of the target security platform that corresponds to the exported rule, the method includes identifying the exported rule as lacking a corresponding integration in the target security platform. In addition, the method includes outputting migration results for the plurality of exported rules, the migration results identifying at least one of: a mapped prebuilt rule, a translated rule, or a missing integration.

Additional objects, features, and advantages of the present disclosure will be apparent from the following detailed description of example embodiments, which proceeds with reference to the accompanying drawings. Like reference numerals generally indicate like elements throughout the drawings.

### BRIEF DESCRIPTION OF THE DRAWINGS

One or more aspects of the present disclosure are described below with reference to the accompanying Figures. For ease of illustration and explanation, the elements shown in the drawings are not necessarily drawn to scale. In some examples, dimensions of certain elements may be exaggerated relative to other elements for clarity, and multiple physical components may be represented in a single functional block or element.

Where appropriate, like reference numerals are used throughout the drawings to indicate corresponding or analogous elements. For clarity, however, not every component is labeled in every Figure. The Figures are provided for purposes of illustration and explanation and are not intended to be limiting. In the Figures:

FIG. 1 sets forth a block diagram illustrating a particular implementation of a system for accelerating security and event management data onboarding with automatic migration.

FIG. 2 is a flowchart that illustrates an implementation of a method of accelerating security and event management data onboarding with automatic migration in accordance with at least one embodiment of the present disclosure.

FIG. 3 is a flowchart that illustrates another implementation of a method of accelerating security and event management data onboarding with automatic migration in accordance with at least one embodiment of the present disclosure.

FIG. 4 is a flowchart that illustrates another implementation of a method of accelerating security and event management data onboarding with automatic migration in accordance with at least one embodiment of the present disclosure.

FIG. 5 is a flowchart that illustrates another implementation of a method of accelerating security and event management data onboarding with automatic migration in accordance with at least one embodiment of the present disclosure.

FIG. 6 is a flowchart that illustrates another implementation of a method of accelerating security and event management data onboarding with automatic migration in accordance with at least one embodiment of the present disclosure.

FIG. 7 is a block diagram of an example computing environment configured for accelerating security and event management data onboarding with automatic migration in accordance with at least one embodiment of the present disclosure.

FIG. 8 is a flowchart illustrating an example method of migrating security detection rules from a source platform to a target platform in accordance with at least one embodiment of the present disclosure.

FIG. 9 is a flowchart illustrating another implementation of a method of migrating security detection rules from a source platform to a target platform in accordance with at least one embodiment of the present disclosure.

FIG. 10 is a flowchart illustrating another implementation of a method of migrating security detection rules from a source platform to a target platform in accordance with at least one embodiment of the present disclosure.

FIG. 11 is a flowchart illustrating another implementation of a method of migrating security detection rules from a source platform to a target platform in accordance with at least one embodiment of the present disclosure.

FIG. 12 is a flowchart illustrating another implementation of a method of migrating security detection rules from a source platform to a target platform in accordance with at least one embodiment of the present disclosure.

FIG. 13 is a flowchart illustrating another implementation of a method of migrating security detection rules from a source platform to a target platform in accordance with at least one embodiment of the present disclosure.

FIG. 14 is a flowchart illustrating another implementation of a method of migrating security detection rules from a source platform to a target platform in accordance with at least one embodiment of the present disclosure.

FIG. 15 is a flowchart illustrating another implementation of a method of migrating security detection rules from a source platform to a target platform in accordance with at least one embodiment of the present disclosure.

FIG. 16 is a flowchart illustrating another implementation of a method of migrating security detection rules from a source platform to a target platform in accordance with at least one embodiment of the present disclosure.

FIG. 17A is a flowchart illustrating an example method of translating an exported security rule from a source platform for use in a target platform in accordance with at least one embodiment of the present disclosure.

FIG. 17B is a flowchart illustrating another implementation of a method of translating an exported security rule from a source platform for use in a target platform in accordance with at least one embodiment of the present disclosure.

FIG. 18 is a flowchart illustrating another implementation of a method of translating an exported security rule from a source platform for use in a target platform in accordance with at least one embodiment of the present disclosure.

FIG. 19 is a flowchart illustrating another implementation of a method of translating an exported security rule from a source platform for use in a target platform in accordance with at least one embodiment of the present disclosure.

FIG. 20 is a flowchart illustrating another implementation of a method of translating an exported security rule from a source platform for use in a target platform in accordance with at least one embodiment of the present disclosure.

FIG. 21 is a flowchart illustrating another implementation of a method of translating an exported security rule from a source platform for use in a target platform in accordance with at least one embodiment of the present disclosure.

FIG. 22 is a flowchart illustrating another implementation of a method of translating an exported security rule from a source platform for use in a target platform in accordance with at least one embodiment of the present disclosure.

FIG. 23 is a flowchart illustrating another implementation of a method of translating an exported security rule from a source platform for use in a target platform in accordance with at least one embodiment of the present disclosure.

FIG. 24 is a flowchart illustrating another implementation of a method of translating an exported security rule from a source platform for use in a target platform in accordance with at least one embodiment of the present disclosure.

FIG. 25 is a flowchart illustrating an example method of onboarding data for migration from a source security platform to a target security platform in accordance with at least one embodiment of the present disclosure.

FIG. 26 is a flowchart illustrating another implementation of a method of onboarding data for migration from a source security platform to a target security platform in accordance with at least one embodiment of the present disclosure.

FIG. 27 is a flowchart illustrating another implementation of a method of onboarding data for migration from a source security platform to a target security platform in accordance with at least one embodiment of the present disclosure.

### DETAILED DESCRIPTION

The terminology used herein is for the purpose of describing particular examples and is not intended to be limiting. As used herein, unless the context clearly indicates otherwise, singular forms such as “a,” “an,” and “the” include plural forms as well. Thus, where a feature, element, or component is described in the singular, additional examples may include a plurality of such features, elements, or components. Likewise, where functionality is described as being implemented using multiple elements, other examples may implement the same functionality using a single element or processing entity. Further, the terms “comprises,” “comprising,” “includes,” and “including” are intended to specify the presence of stated features, integers, steps, operations, acts, elements, or components, but do not preclude the presence or addition of one or more other features, integers, steps, operations, acts, elements, components, or groups thereof.

It will be understood that when an element is described as being “connected” or “coupled” to another element, the element may be directly connected or coupled to the other element, or may be connected or coupled through one or more intervening elements. Further, if elements A and B are described in the alternative using “or,” such disclosure is intended to encompass only A, only B, and both A and B. The phrase “at least one of A and B” is intended to convey the same set of alternatives. The same understanding applies to combinations of more than two elements.

Accordingly, although various examples are capable of modification and alternative forms, particular examples are shown in the Figures and described in detail herein. The detailed description is not intended to limit the disclosure to the particular forms described. Rather, the disclosure is intended to cover modifications, equivalents, and alternatives falling within the scope of the disclosure. Like reference numerals generally refer to like or similar elements throughout the Figures and description, although such elements may be implemented identically or differently while providing the same or similar functionality.

Establishing and maintaining visibility across an enterprise information technology environment is challenging, particularly as the attack surface changes over time. Security teams cannot afford gaps in visibility, even as applications are developed, systems are added, and infrastructure is migrated to cloud environments. Custom data onboarding, however, remains costly and complex. As organizations evaluate replacement of legacy Security Information and Event Management (SIEM) tools, collecting and normalizing data is often among the earliest phases of migration, beginning with available out-of-the-box data integrations. Custom connectors typically must be developed for unsupported technologies, and manual development of such connectors can slow adoption of a target SIEM and delay retirement of the legacy solution.

Embodiments described herein include a system that uses machine learning, including generative artificial intelligence, to automate SIEM data onboarding and identification of integrations relevant to migrated rules. This approach reduces the time, effort, and complexity associated with identifying and validating integrations relevant to onboarding security-relevant data into a target platform. In some examples, the system is model-agnostic and leverages capabilities of one or more large language models. In some further examples, retrieval-augmented generation may be used to provide contextual information for the model, including proprietary or platform-specific information relevant to migration and translation.

In some examples, the system identifies whether exported detection rules from a source platform correspond to prebuilt detection rules of a target platform, thereby allowing corresponding target-platform rules to be selected and activated without requiring rule-by-rule manual recreation. Where no corresponding target-platform rule is identified, the system translates the exported rule for use in the target platform. The translated rule may then be provided for review, installation, or deployment in the target platform. In this way, exported SIEM rules may be either mapped to existing target-platform rules or translated into target-platform content using the machine learning model.

In some examples, a user may provide exported rules, macros, lookups, or other custom elements from a source platform, and the system may use those inputs to generate migration results. The system may identify integrations of the target platform that correspond to exported rules, indicate where corresponding integrations are unavailable, and provide recommendations regarding integrations to be installed to support migrated rules. In some implementations, multiple migrations from multiple source environments may be processed, thereby facilitating consolidation into a target environment. By automating rule correspondence determination, translation, integration identification, and related onboarding operations, the disclosed approach reduces the knowledge barrier between platforms and improves the speed and consistency of migration from a source SIEM to a target SIEM.

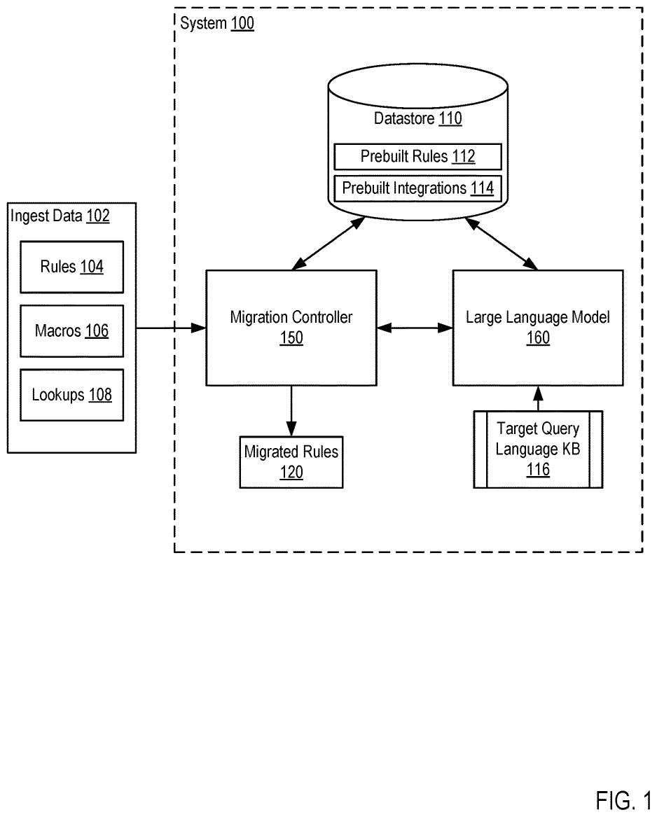

For further explanation, FIG. 1 sets forth a block diagram of an example system for accelerating security and event management data onboarding with automatic migration in accordance with at least one embodiment of the present disclosure. The system 100 includes a migration controller 150 that migrates rules, such as SIEM rules, implemented on source platform to a target platform. By way of example and not limitation, the source platform may be Splunk and the target platform may be Elasticsearch. These may be used as illustrative examples throughout the following description. The migration is performed with the aid of a large language model 160. Thus, the system 100 automates the migration of SIEM rules for use in the target platform, significantly reducing the amount of time to perform and migration and the human effort needed to carry it out.

The system 100 includes ingest data 102 exported from the source platform that is supplied by a user to the migration controller 150 for migration from the source platform (e.g., Splunk) to the target platform (e.g., Elasticsearch). For example, ingest data 102 may take the form of JavaScript Object Notation (JSON) files, CSV files, and the like. Ingest data 102 includes one or more rules 104, such as security rules (e.g., SIEM rules). In some examples, a rule 104 includes a rule title, a rule description, a query, and metadata. For example, the rule title may describe the function of the rule generally, such “Excessive Failed Logins.” The rule description may describe the rule with more particularity, such as “User $user$ from IP $src_ip$ has failed login more than 10 times in the last 10 minutes, indicating a brute-force attack.” The query may include queries, macros, and lookups directed to source datasets such as logs and other security data. For example, the query “index=auth=action=failure| stats count by user, src_ip| where count >10” searches authentication logs, aggregates failed login attempts per user and IP address, and flags users with more than 10 failed login attempts. The query may be written in a source query language. As an illustrative example, as mentioned above, the query may be a Splunk Processing Language (SPL) query, although it will be appreciated that embodiments of the present disclosure are not limited by this example. The rule 104 may also include other metadata, such as the application, search type, search schedule, trigger condition, severity, risk score, risk object, ATT&CK mapping, and so on. The rule 104 may also include adaptive response actions, such as emailing an administrator, or a security orchestration, automation, and response (SOAR) action, such as blocking the IP address in the firewall.

Ingest data 102 can also include macros 106 and lookups 108. A macro 106 may be a reusable search expression used to simplify complex queries, improve readability, and ensure consistency across multiple searches. A lookup 108 may be an expression to add external reference data to enrich the results of the query, such as a user's full name and department in the example above. As the query may include macros 106 and lookups 108, to properly translate the query those macros and lookups must be expanded. Since the specific actions taken or data used by a macro/lookup may not be readily ascertainable from the query, the source platform's exported macros and lookups should be included in the ingest data. For example, an illustrative macro may be ‘index=auth_logs action=failed’ and a query using the macro may be “‘failed_logins’| stats count by user, src_ip| where count >5.” When the macro is expanded, the query would read “index=auth_logs action=failed| stats count by user, src_ip| where count >5.” Thus, the user uploads the macros 106 to the system to facilitate translation of queries that include macros. The same may be done for lookups. Any other custom elements used by the rules 104 should also be included.

The system 100 also includes a datastore 110 including prebuilt rules 112 and prebuilt integrations 114 of the target platform. For example, the prebuilt rules 112 can include rules based on the target platform including queries directed to indexes and integrations in the target platform. The prebuilt rules may be similar to the rules 104 in that prebuilt rules also include a title, description, query, metadata, and so on. The prebuilt integrations 114 can include, for example, prebuilt interfaces and connectors to collect logs, metrics, and security data from various systems, such as Windows, Apache, SIEM tools, cloud services, and other existing platforms.

The system 100 also includes a target query language knowledgebase 116. The target query language knowledgebase 116 supplies data to augment the large language model to improve inferencing for generating outputs in the target query language. For example, the target query language knowledgebase 116 may be an Elastic Search Query Language or Kibana knowledgebase that conveys the syntax and semantics of the target query language.

Using the ingest data 102, the prebuilt rules 112, prebuilt integrations 114, the large language model 160, the target query language knowledgebase, and source/target data models, migration controller 150 outputs a set of migrated rules 120 that include mapped prebuilt rules and/or translated rules. Migration controller 150 also identifies missing integrations for the migrated rules. Where a rule 104 could not be translated, or only partially translated, migration controller 150 identifies the rule and any portion of the rule that could not be translated. The migrated rules 120 may include similar elements as the rules 104, including rule name, description, query, and metadata. The migrated rules 120 are ready for installation and deployment on the target platform. The process of rule migration is described in more detail below.

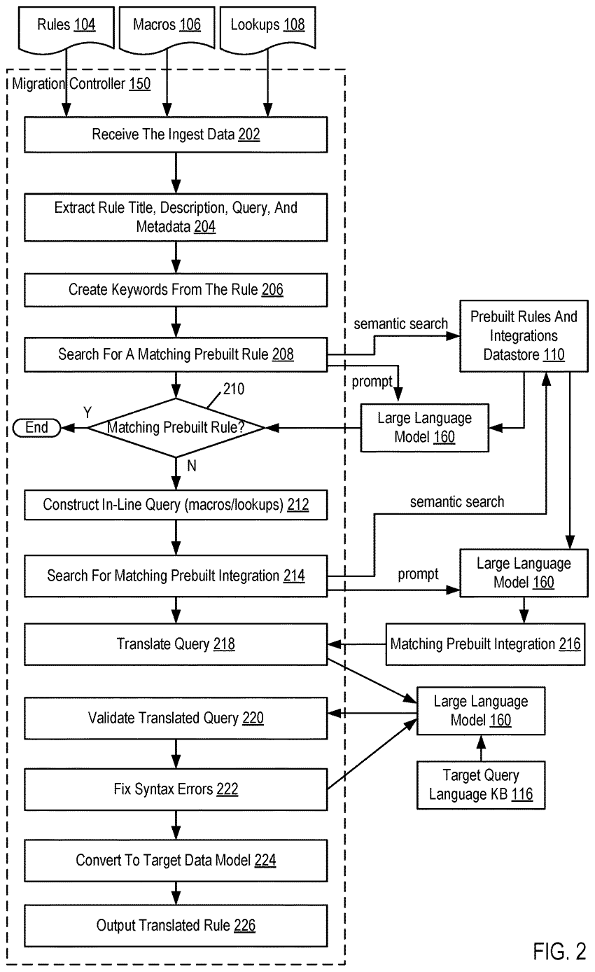

For further explanation, FIG. 2 sets forth a flow chart of an example method of accelerating security and event management data onboarding with automatic migration in accordance with at least one embodiment of the present disclosure. At step 202, the migration controller 150 receives the ingest data 102 exported from the source platform via user upload, including the set of rules 104 and optionally the macros 106 and lookups 108. For example, the ingest data may be exported as JSON. For each rule in the set of rules, the migration controller 150 initiates a migration of the rule. For a particular rule, at step 204, the migration controller 150 extracts the rule title, description, query, and metadata from the exported rule 104 (e.g., from the JSON). At step 206, the migration controller 150 creates keywords from the rule 104 (e.g., windows, process, creation, command line, Sysmon, etc.). At step 208, the migration controller searches for a matching prebuilt rule from the prebuilt rules 112 in the datastore 110 using a sematic search based on the keywords. The results returned from the semantic search may be scored. For example, they may be scored for different fields, such as data model fields. In some examples, the migration controller 150 prompts the large language model 160 to select a matching rule from the semantic search results using the title, description, and metadata of the exported rule 104 as contextual information for retrieval augmented generation. The large language model 160 may select a prebuilt rule 112 based on a degree of confidence or may determine that there is no matching prebuilt rule 112. If a matching prebuilt rule is identified at step 210, the migration controller 150 maps the exported rule 104 to the prebuilt rule 112 and the migration process ends for that rule. If a matching prebuilt rule is not identified, the flow proceeds to step 212.

At step 212, rule translation begins by constructing an in-line query from the source query that includes an expansion of any macros and lookups present in the query. For example, if a macro is identified in the rule, the migration controller 150 finds the definition for the macro in the exported macros 106 and includes those expressions in the in-line query. For example, the migration controller 150 may expand the macros in an SPL query so that no macros are present for translation. The same can be done for lookups in the query. At step 214, the migration controller 150 searches for a matching prebuilt integration 114 through a semantic search of the prebuild integrations 114 based on an indexing pattern identified from the in-line query. In some examples, the migration controller 150 prompts the large language model 160 to select a matching prebuilt integration from the results of the semantic search using the rule title, description, and metadata as context for retrieval augmented generation. The large language model 160 may select a prebuilt integration 114 as matching integration based on a degree of confidence or may determine that there is no matching prebuilt integration. If a matching prebuilt integration is identified at step 216, the migration controller 150 maps the query to the prebuilt integration and proceeds to query translation. If no prebuilt integration is identified, the migration controller 150 may still proceed to partial query translation and identify that the translated rule is missing an integration, or may simply fail the migration and return no rule translation.

At step 218, the migration controller 150 prompts the large language model 160 to translate the query from the source query language to the target language (e.g., from SPL to ESQL). As mentioned above, the large language model 160 may include an inferencing plugin based on the target query language knowledge base. This plugin may map natural language to the target query language. At step 220, the migration controller 150 validates the syntax of the translated query. In some examples, at step 222, the migration controller 150 may prompt the large language model 160 to fix any syntax errors detected in the translated query. A maximum number of translation attempts may be enforced. If a syntactically valid query translation is achieved, at step 224 the migration controller uses the large language model 160 to convert the source data model (e.g., Common Information Model in Splunk) to a target data model (e.g., Elastic Common Schema) by mapping field names in log files, categories, and the like in the source data model to correspond field names, categories, and so on in the target data model. For example, for firewall logs, migration controller may map ‘src’ in Splunk to ‘source.ip’ in Elasticsearch. Similar conversions can be made for categories such as event, host, user, etc. (e.g., event.id in Elasticsearch). At step 226, the migration controller outputs the translated rule. The translated rule uses the translated query based on the target query language, prebuilt or missing integrations, and target data model. The translated rule also includes a translated title, description, and metadata.

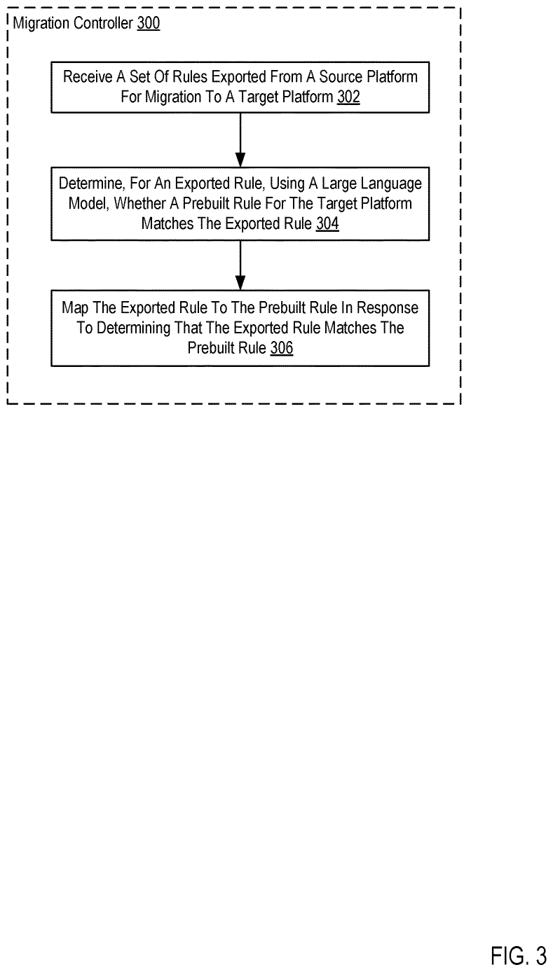

For further explanation, FIG. 3 sets forth a flowchart of an example method of accelerating security and event management data onboarding with automatic migration in accordance with the present disclosure. The method of FIG. 3 includes receiving 302 a set of rules exported from a source platform for migration to a target platform. In some examples, a migration controller 300 receives the set of rules via user upload. For example, the rules may be exported in JSON. A rule may include a title, description, query, and metadata as discussed above. In some examples, migration controller 300 also receives macros and/or lookups that have been exported from the source platform.

The method of FIG. 3 also includes determining 304, for each exported rule, using a large language model, whether a prebuilt rule for the target platform matches the exported rule. In some examples, matching the exported rule to a prebuilt rule is facilitated by a large language model or other artificial intelligence In some examples, the migration controller 300 determines 304 whether the exported rule matches the prebuilt rule using the large language model by configuring the large language model to use an index of prebuilt rules for the target platform as a context for retrieval augmented generation, and providing the exported rule (including the rule title, description, query, and metadata) as input to the large language model for selecting a matching prebuilt rule. If the large language model identifies a matching prebuilt rule, the matching prebuilt rule is identified to the migration controller 300.

The method of FIG. 3 also includes mapping 306 the exported rule to the prebuilt rule in response to determining that the exported rule matches the prebuilt rule. In some examples, the migration controller 300 maps 306 the exported rule to the prebuilt rule by adding the prebuilt rule to a configuration file or other data structure associated with the user's account. In some examples, the mapping is displayed to a user in a graphical user interface.

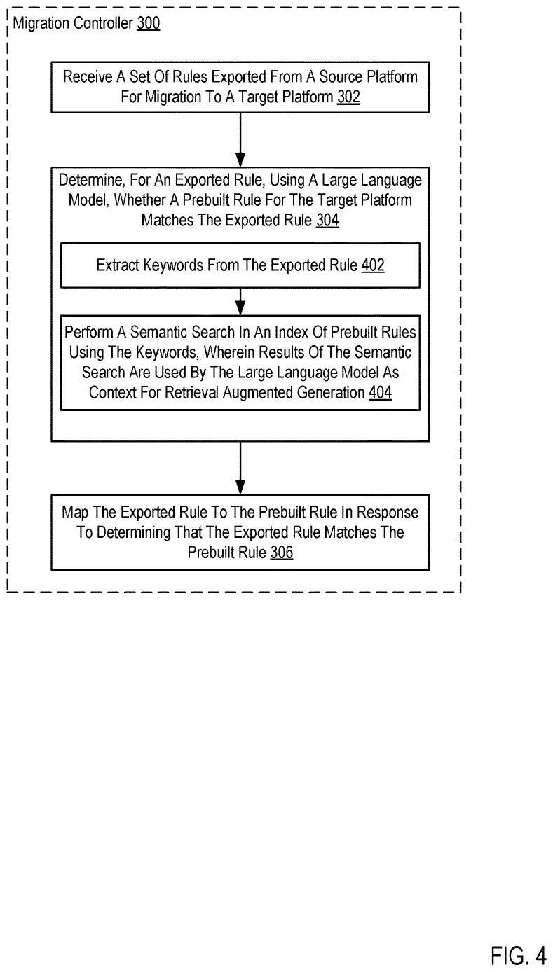

For further explanation, FIG. 4 sets forth a flowchart of another example method of accelerating security and event management data onboarding with automatic migration in accordance with the present disclosure. The method of FIG. 4 extends the method of FIG. 3 in that determining 304, for each exported rule, using a large language model, whether a prebuilt rule for the target platform matches the exported rule includes extracting 402 keywords from the exported rule. Determining 304, for each exported rule, using a large language model, whether a prebuilt rule for the target platform matches the exported rule also includes performing 404 a semantic search in an index of prebuilt rules using the keywords, wherein results of the semantic search are used by the large language model as context for retrieval augmented generation. In some examples, the migration controller prompts the large language model to identify a matching prebuilt rule based on the exported rule, for example, by providing the rule title, description, query and metadata to the large language model and configuring the large language model to use the results of the semantic search for retrieval augmented generation in identifying a matching prebuilt rule.

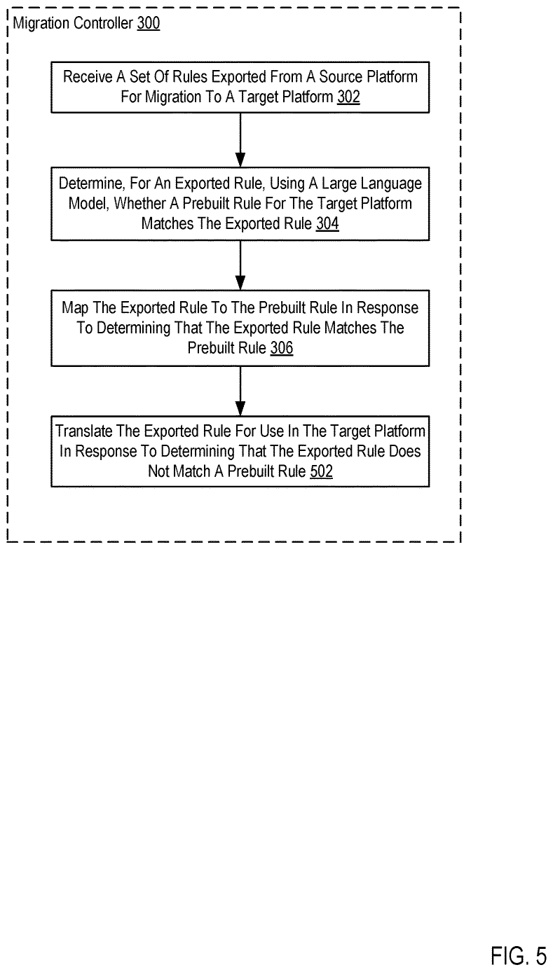

For further explanation, FIG. 5 sets forth a flowchart of another example method of accelerating security and event management data onboarding with automatic migration in accordance with the present disclosure. The method of FIG. 5 extends the method of FIG. 3 in that the method of FIG. 5 also includes translating 502 the exported rule for use in the target platform in response to determining that the exported rule does not match a prebuilt rule. In some examples, the migration controller 300 translates 502 the exported rule by translating the query in the exported rule from the source query language to the target query language. In some examples, the migration controller 300 detects whether the query includes a macro. In such examples, the migration controller expands the macro in the query using the exported macros uploaded by the user. In some examples, the migration controller 300 translates the query using the large language model. For example, the machine learning model may be configured with an inferencing plugin or inferencing knowledge base that supplies semantics and/or natural language description of the target query language to the large language model. In this way, the large language model may generate queries in the target query language that achieve the same functionality as the query in the exported rule. In some examples, the migration controller 150 validates the syntax of the translated query output by the large language model. In such examples, the migration controller 300 may utilize the large language model to correct any syntax errors, for example, by supplying the syntax errors to the large language model and prompting the large language model to regenerate a translated query.

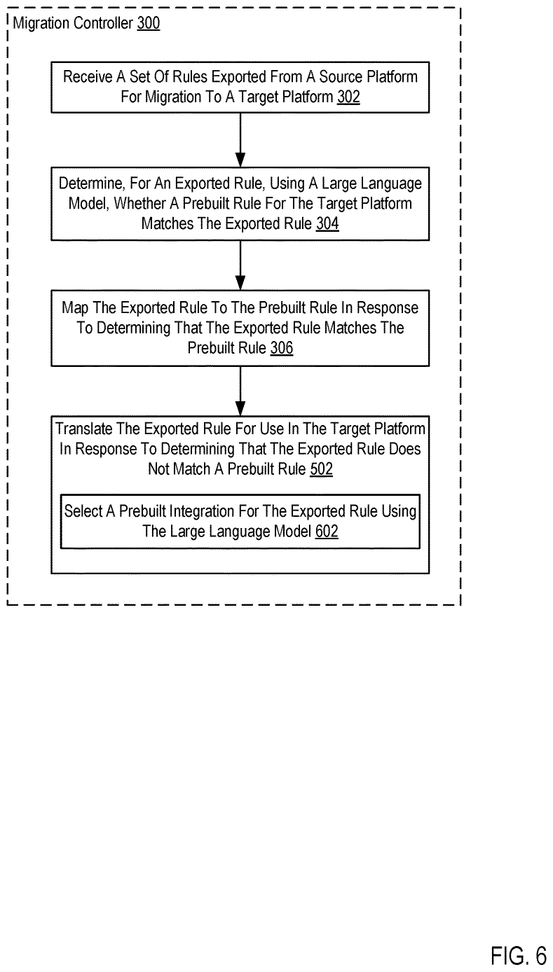

For further explanation, FIG. 6 sets forth a flowchart of another example method of accelerating security and event management data onboarding with automatic migration in accordance with the present disclosure. The method of FIG. 6 extends the method of FIG. 5 in that translating 502 the exported rule for use in the target platform includes selecting 602 a prebuilt integration for the exported rule. In some examples, the migration controller 300 selects 602 a prebuilt integration by determining whether a prebuilt integration exists for the exported rule based on an indexing pattern in the query. In some implementations, the migration controller uses the indexing pattern for a semantic search of an index of prebuilt integrations. In some examples, the large language model is used to identify a matching integration in the index of prebuilt integrations. In some implementations, the results of the semantic search are provided as context for retrieval augmented generation, through which the large language model selects a prebuilt integration if a matching integration exists.

In view of the foregoing, it will be appreciated that accelerating security and event management data onboarding with automatic migration improves the efficiency of data migration from a source platform to a target platform through AI-driven identification and mapping of a customer's SIEM rules in the source platform to existing SIEM rules in the target platform, as well as AI-driven translation of the SIEM rule where no such mapping exists, thus advancing the security of customer data and improving the security of computer systems.

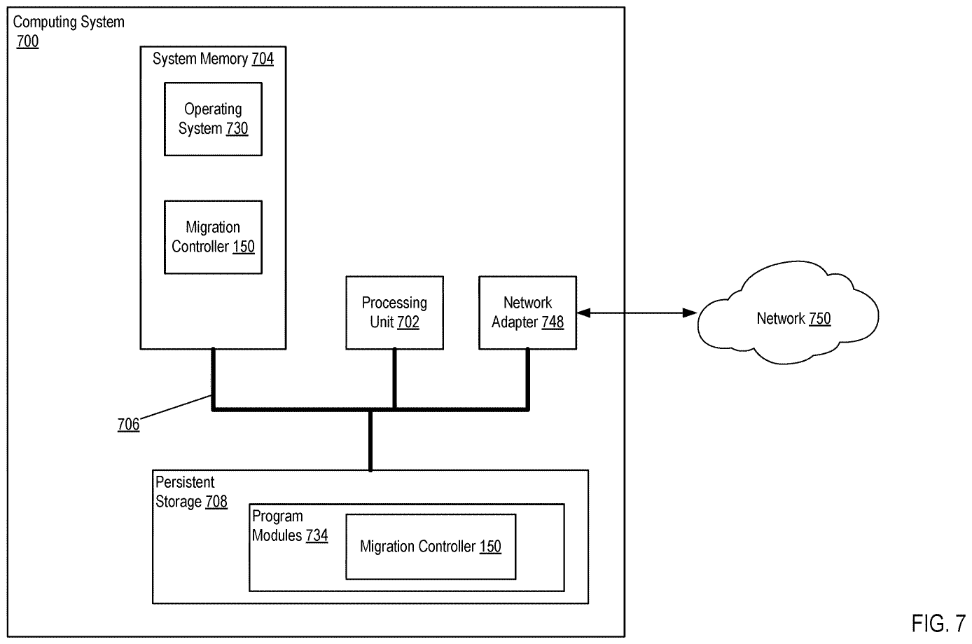

For further explanation, FIG. 7 depicts an example computer 700 in which embodiments may be implemented. Any element of system 100 may be implemented using computer 700, including one or more features of computer 700 and/or alternative features. The description of computer 700 provided herein is provided for the purposes of illustration and is not intended to be limiting. Embodiments may be implemented in further types of computer systems, as would be known to persons skilled in the relevant art(s).

As shown in FIG. 7, computer 700 includes a processing unit 702, a system memory 704, and a bus 706 that couples various system components including system memory 704 to processing unit 702. Bus 706 represents one or more of any of several types of bus structures, including a memory bus or memory controller, a peripheral bus, an accelerated graphics port, and a processor or local bus using any of a variety of bus architectures. System memory 704 includes random access memory (RAM).

Computer 700 also has persistent storage 708 in the form of, for example, a magnetic disk or a solid-state drive connected to bus 706 by bus interface. The persistent storage 708 and their associated computer-readable storage media provide nonvolatile storage of computer-readable instructions, data structures, program modules and other data for the computer. Although a magnetic disk and solid-state driver are described, other types of computer-readable storage media can be used to store data.

An operating system 730 and number of program modules 734 may be stored in persistent storage 708. Application program modules 734 may include, for example, computer program logic for implementing migration controller 150 or migration controller 300.

Computer 700 is connected to a network 750 (e.g., the Internet) through a network interface or adapter 748, or other means for establishing communications over the network. For example, network 750 may be used for communication with a user and with large language model 160.

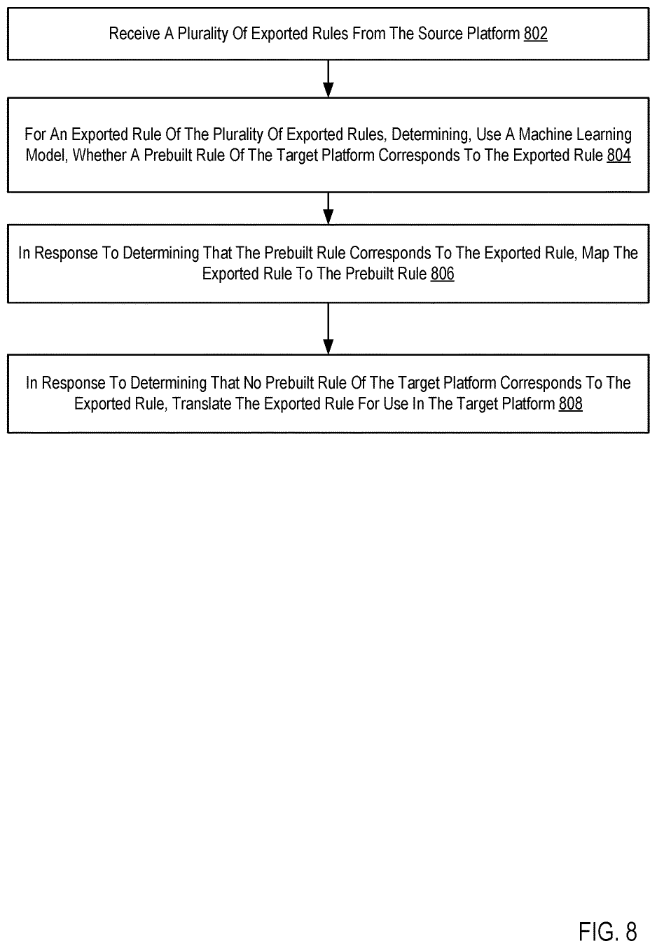

For further explanation, FIG. 8 sets forth a flowchart of an example method of migrating security detection rules from a source platform to a target platform in accordance with the present disclosure. In some examples, the method of FIG. 8 may be carried out by a migration controller configured to process exported rules from the source platform and determine whether each exported rule can be satisfied by an existing prebuilt rule of the target platform or, alternatively, translated for use in the target platform.

The method of FIG. 8 includes receiving 802 a plurality of exported rules from the source platform. Receiving 802 a plurality of exported rules from the source platform may be carried out by a migration controller that receives, through a user interface or application programming interface, an uploaded export file generated by the source platform. In some examples, the export file may be a JSON file, CSV file, or other structured file that includes multiple exported security detection rules and, optionally, associated custom elements such as macros and lookups referenced by the rules. The migration controller may parse the uploaded file to identify the individual exported rules and extract rule information for subsequent correspondence determination and translation processing.

The method of FIG. 8 also includes for an exported rule of the plurality of exported rules, determining 804, using a machine learning model, whether a prebuilt rule of the target platform corresponds to the exported rule. For an exported rule of the plurality of exported rules, determining 804, using a machine learning model, whether a prebuilt rule of the target platform corresponds to the exported rule may be carried out by extracting information from the exported rule, such as a title, description, query, and metadata, and providing that information to the machine learning model. In some examples, the system may generate one or more keywords from the exported rule and perform a semantic search of an index of prebuilt rules of the target platform to identify candidate prebuilt rules. Results of the semantic search may be provided as context to the machine learning model, which evaluates the exported rule relative to the candidate prebuilt rules and selects a prebuilt rule that corresponds to the exported rule, or determines that no such prebuilt rule corresponds.

In addition, the method of FIG. 8 also includes in response to determining that the prebuilt rule corresponds to the exported rule, mapping 806 the exported rule to the prebuilt rule. In response to determining that the prebuilt rule corresponds to the exported rule, mapping 806 the exported rule to the prebuilt rule may be carried out by associating the exported rule with an identifier of the corresponding prebuilt rule in a data structure maintained by the migration controller. In some examples, the system may store the association in a configuration file, migration results file, or account-specific rule set so that the corresponding prebuilt rule can be activated or installed in the target platform in place of translating the exported rule. The mapping may also include presenting, in a user interface, an indication that the exported rule has been satisfied by the corresponding prebuilt rule of the target platform. In this way, the system reuses an existing prebuilt rule of the target platform for the exported rule instead of generating a new translated rule.

The method of FIG. 8 also includes in response to determining that no prebuilt rule of the target platform corresponds to the exported rule, translating 808 the exported rule for use in the target platform. In response to determining that no prebuilt rule of the target platform corresponds to the exported rule, translating 808 the exported rule for use in the target platform may be carried out by generating a translated version of the exported rule that is compatible with the target platform. In some examples, the system may construct an in-line query by expanding macros or lookups referenced in a source query of the exported rule, and may use a machine learning model to translate the in-line query from a source query language to a target query language. The system may further validate syntax of the translated query, correct detected syntax errors, and convert the exported rule from a source data model to a target data model associated with the target platform. In this way, the system produces a translated rule suitable for installation and use in the target platform when no corresponding prebuilt rule is available.

In at least some embodiments, system 800 improves operation of a target security analytics platform by automatically converting source-platform detection content into platform-compatible detection content for the target platform using platform-specific technical constraints, translation, and validation. For example, system 800 can receive exported rules from a source platform, extract rule information, perform semantic searches of prebuilt rules and prebuilt integrations, expand macros and lookups into an in-line query, translate the in-line query into a target query language, validate the translated query, correct detected syntax errors, convert referenced source-platform data fields to a target-platform data model, and output a translated rule for deployment in the target platform. System 800 can also determine whether an exported rule corresponds to a prebuilt rule of the target platform and, when no corresponding prebuilt rule is identified, generate a translated rule for use in the target platform. By reusing corresponding prebuilt rules where available and translating other exported rules when needed, system 800 improves interoperability between heterogeneous security platforms and enables the target platform to deploy and execute migrated security content using target-platform query syntax, target-platform integrations, and a target-platform data model, thereby reducing incompatibility between source-platform detection content and target-platform execution requirements, reducing translation error, and improving the efficiency, consistency, reliability, and speed of migration and deployment of security detection content within the target platform.

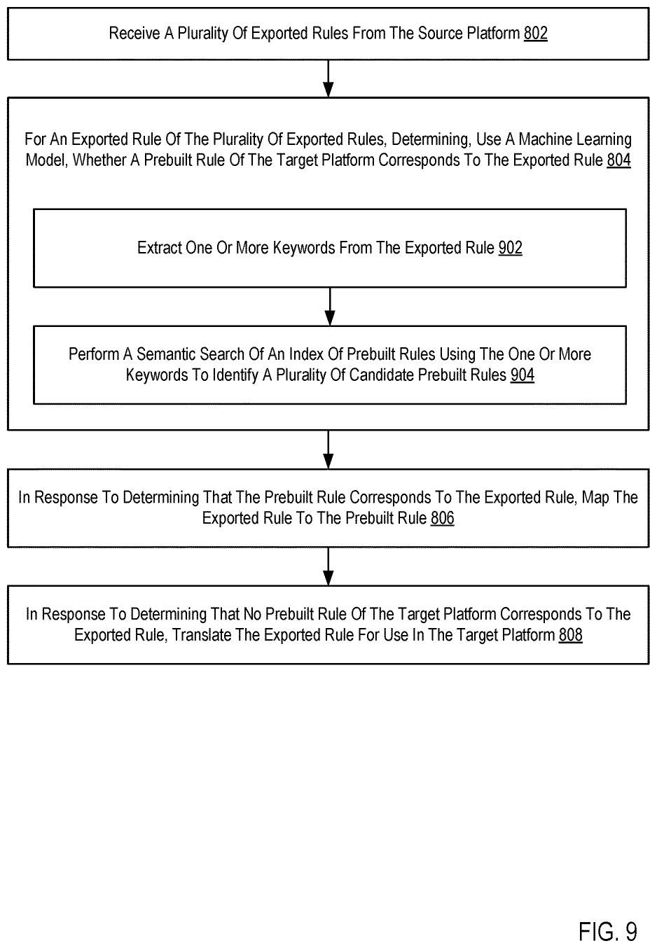

For further explanation, FIG. 9 sets forth a flowchart of another example method of migrating security detection rules from a source platform to a target platform in accordance with the present disclosure. The method of FIG. 9 is similar to the method of FIG. 8 in that the method of FIG. 9 includes all of the elements of FIG. 8.

In the method of FIG. 9, determining 804 whether the prebuilt rule corresponds to the exported rule further comprises extracting 902 one or more keywords from the exported rule. Extracting 902 one or more keywords from the exported rule may be carried out by extracting the rule title, description, query, and metadata from the exported rule and creating keywords from that extracted rule information. In some examples, the migration controller creates keywords from the exported rule for use in a semantic search of prebuilt rules of the target platform. Example keywords may include terms reflected in the exported rule, such as “Windows,” “process,” “creation,” “command line,” or “Sysmon.” In this way, the system derives one or more keywords from the exported rule for identifying candidate prebuilt rules that may correspond to the exported rule.

In addition, determining 804 whether the prebuilt rule corresponds to the exported rule further comprises performing 904 a semantic search of an index of prebuilt rules using the one or more keywords to identify a plurality of candidate prebuilt rules. Performing 904 a semantic search of an index of prebuilt rules using the one or more keywords to identify a plurality of candidate prebuilt rules may be carried out by querying an index of prebuilt rules of the target platform using the one or more keywords created from the exported rule. In some examples, the migration controller searches the index of prebuilt rules based on the keywords and obtains search results identifying multiple prebuilt rules that are potentially relevant to the exported rule. The search results may include a plurality of candidate prebuilt rules for further evaluation in determining whether a prebuilt rule of the target platform corresponds to the exported rule.

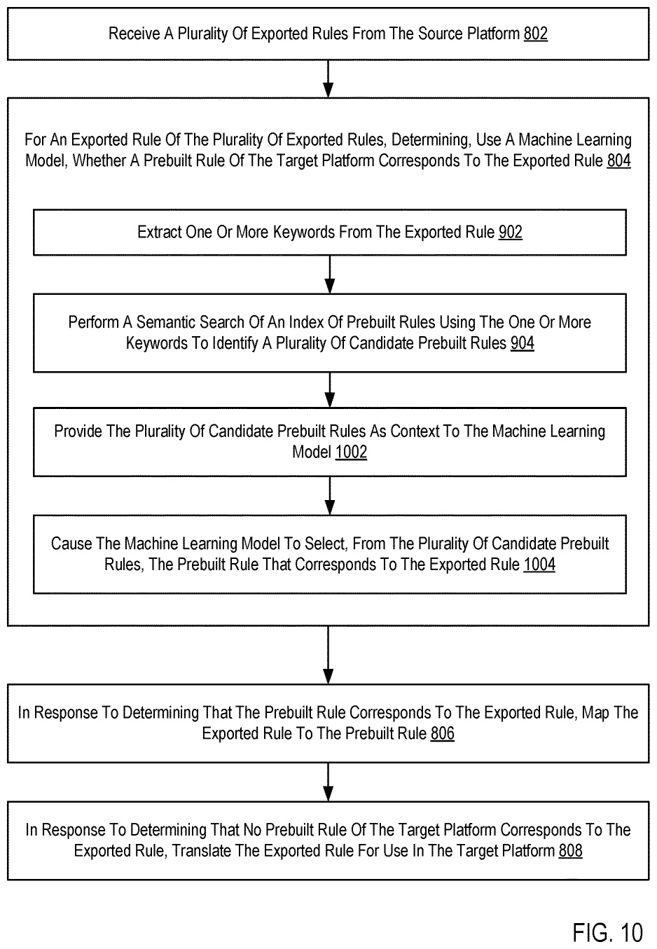

For further explanation, FIG. 10 sets forth a flowchart of another example method of migrating security detection rules from a source platform to a target platform in accordance with the present disclosure. The method of FIG. 10 is similar to the method of FIG. 9 in that the method of FIG. 10 includes all of the elements of FIG. 9.

In the method of FIG. 10, determining 804 whether the prebuilt rule corresponds to the exported rule further comprises providing 1002 the plurality of candidate prebuilt rules as context to the machine learning model. Providing 1002 the plurality of candidate prebuilt rules as context to the machine learning model may be carried out by supplying the candidate prebuilt rules identified by the semantic search to the machine learning model together with information from the exported rule. In some examples, the candidate prebuilt rules serve as context used by the machine learning model in determining whether one of the prebuilt rules corresponds to the exported rule. The machine learning model may evaluate the exported rule relative to the candidate prebuilt rules and select a prebuilt rule that corresponds to the exported rule, or determine that no such prebuilt rule corresponds.

In addition, in the method of FIG. 10, determining 804 whether the prebuilt rule corresponds to the exported rule further comprises causing 1004 the machine learning model to select, from the plurality of candidate prebuilt rules, the prebuilt rule that corresponds to the exported rule. Causing 1004 the machine learning model to select, from the plurality of candidate prebuilt rules, the prebuilt rule that corresponds to the exported rule may be carried out by providing the machine learning model with the plurality of candidate prebuilt rules and information from the exported rule, such as the title, description, query, and metadata. In some examples, the machine learning model evaluates the exported rule relative to the candidate prebuilt rules and selects a prebuilt rule of the target platform that corresponds to the exported rule. If the machine learning model does not identify a corresponding prebuilt rule from the plurality of candidate prebuilt rules, the system may determine that no prebuilt rule of the target platform corresponds to the exported rule. I

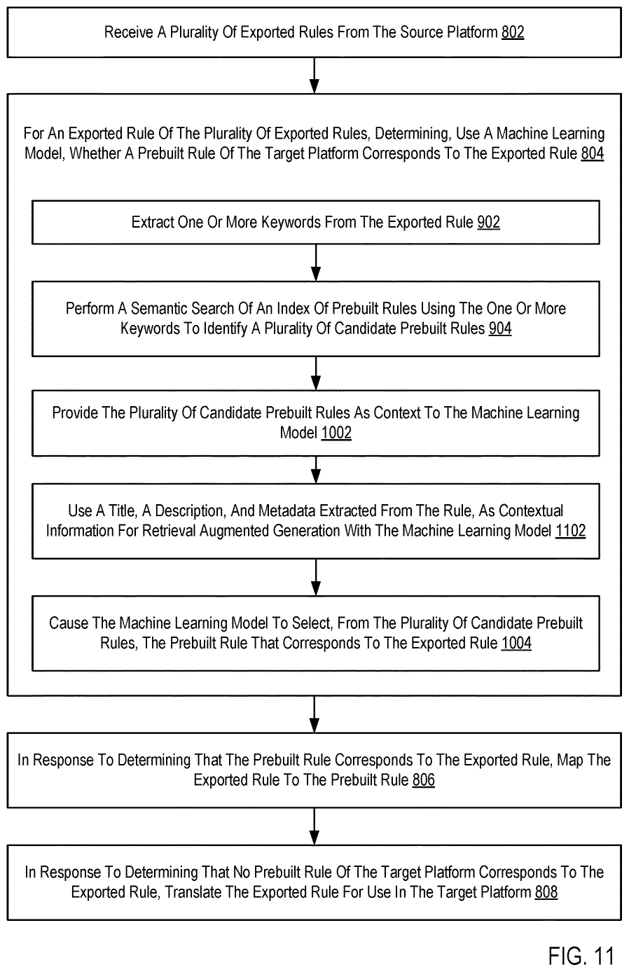

For further explanation, FIG. 11 sets forth a flowchart of another example method of migrating security detection rules from a source platform to a target platform in accordance with the present disclosure. The method of FIG. 11 is similar to the method of FIG. 10 in that the method of FIG. 11 includes all of the elements of FIG. 10.

In the method of FIG. 11, determining 804 whether the prebuilt rule corresponds to the exported rule further comprises using 1102 a title, a description, and metadata extracted from the rule, as contextual information for retrieval augmented generation with the machine learning model. Using 1102 a title, a description, and metadata extracted from the rule, as contextual information for retrieval augmented generation with the machine learning model may be carried out by extracting the title, description, and metadata from the exported rule and providing that information to the machine learning model together with the plurality of candidate prebuilt rules. In some examples, the extracted title, description, and metadata provide context that assists the machine learning model in evaluating the exported rule relative to the candidate prebuilt rules. The machine learning model may use that contextual information in selecting a prebuilt rule that corresponds to the exported rule, or in determining that no prebuilt rule corresponds to the exported rule.

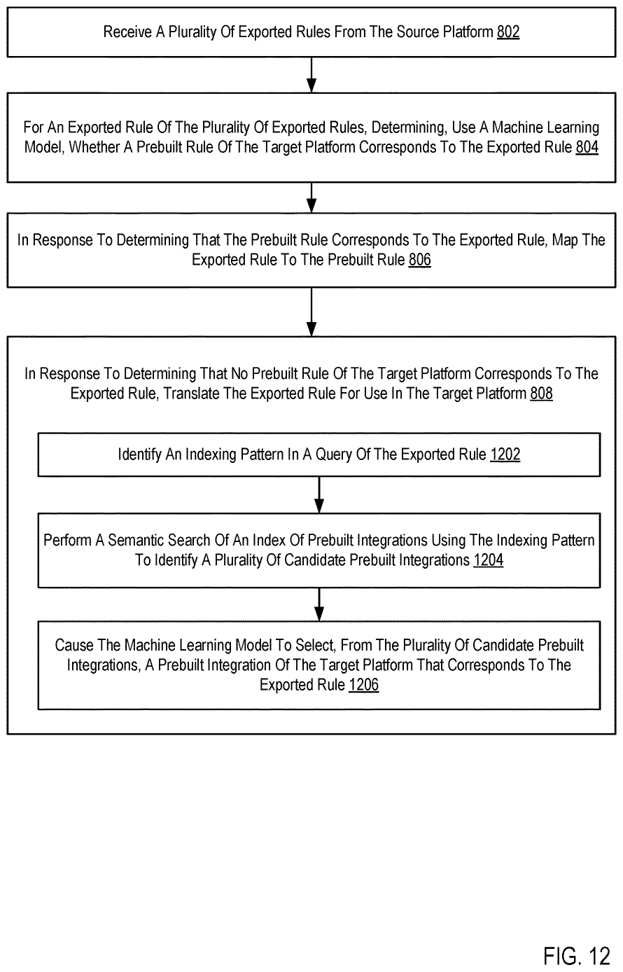

For further explanation, FIG. 12 sets forth a flowchart of another example method of migrating security detection rules from a source platform to a target platform in accordance with the present disclosure. The method of FIG. 12 is similar to the method of FIG. 8 in that the method of FIG. 12 includes all of the elements of FIG. 8.

In the method of FIG. 12, translating 808 the exported rule comprises identifying 1202 an indexing pattern in a query of the exported rule. Identifying 1202 an indexing pattern in a query of the exported rule may be carried out by examining the query of the exported rule to determine an indexing pattern referenced by the query. In some examples, the migration controller identifies the indexing pattern from the query after constructing an in-line query for the exported rule. The identified indexing pattern may be used in searching prebuilt integrations of the target platform during translation of the exported rule.

In addition, in the method of FIG. 12, translating 808 the exported rule comprises performing 1204 a semantic search of an index of prebuilt integrations using the indexing pattern to identify a plurality of candidate prebuilt integrations. Performing 1204 a semantic search of an index of prebuilt integrations using the indexing pattern to identify a plurality of candidate prebuilt integrations may be carried out by searching an index of prebuilt integrations of the target platform based on the indexing pattern identified from the query of the exported rule. In some examples, the migration controller uses the indexing pattern to obtain search results identifying multiple prebuilt integrations that are potentially relevant to the exported rule. The search results may include a plurality of candidate prebuilt integrations for further evaluation in determining whether a prebuilt integration of the target platform corresponds to the exported rule.

Translating 808 the exported rule also includes causing 1206 the machine learning model to select, from the plurality of candidate prebuilt integrations, a prebuilt integration of the target platform that corresponds to the exported rule. Causing 1206 the machine learning model to select, from the plurality of candidate prebuilt integrations, a prebuilt integration of the target platform that corresponds to the exported rule may be carried out by providing the machine learning model with the plurality of candidate prebuilt integrations identified by the semantic search and information from the exported rule. In some examples, the machine learning model evaluates the exported rule relative to the candidate prebuilt integrations and selects a prebuilt integration of the target platform that corresponds to the exported rule. If the machine learning model does not identify a corresponding prebuilt integration from the plurality of candidate prebuilt integrations, the system may determine that the exported rule lacks a corresponding integration in the target platform.

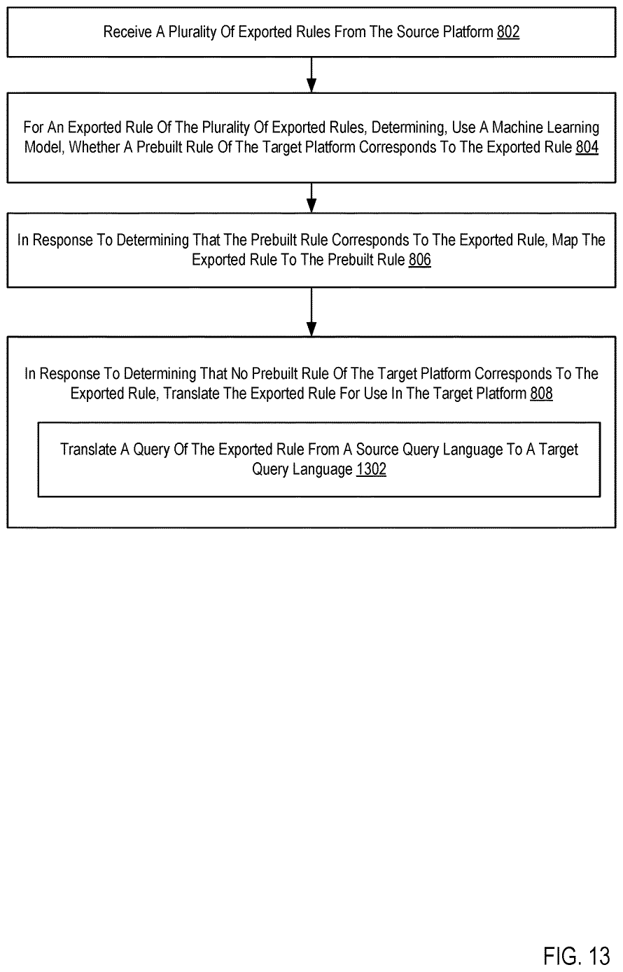

For further explanation, FIG. 13 sets forth a flowchart of another example method of migrating security detection rules from a source platform to a target platform in accordance with the present disclosure. The method of FIG. 13 is similar to the method of FIG. 8 in that the method of FIG. 13 includes all of the elements of FIG. 8.

In the method of FIG. 13, translating 808 the exported rule comprises translating 1302 a query of the exported rule from a source query language to a target query language. Translating 1302 a query of the exported rule from a source query language to a target query language may be carried out by providing the query of the exported rule to the machine learning model and causing the machine learning model to generate a translated query in the target query language. In some examples, the query may first be constructed as an in-line query by expanding macros or lookups referenced in the exported rule so that the machine learning model translates the resulting in-line query. The translated query is generated for use in the target platform in place of the query of the exported rule from the source platform.

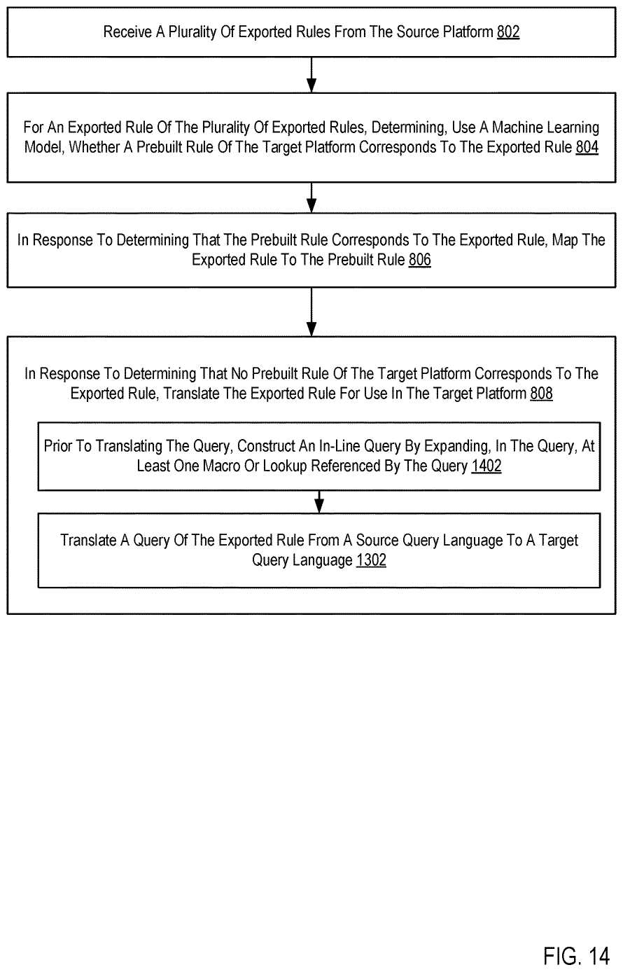

For further explanation, FIG. 14 sets forth a flowchart of another example method of migrating security detection rules from a source platform to a target platform in accordance with the present disclosure. The method of FIG. 14 is similar to the method of FIG. 13 in that the method of FIG. 14 includes all of the elements of FIG. 13.

In the method of FIG. 14, translating 808 the exported rule comprises prior to translating the query, constructing 1402 an in-line query by expanding, in the query, at least one macro or lookup referenced by the query. Prior to translating the query, constructing 1402 an in-line query by expanding, in the query, at least one macro or lookup referenced by the query may be carried out by identifying a macro or lookup referenced in the query of the exported rule and obtaining a definition of the macro or lookup from exported custom elements received with the exported rule. In some examples, the migration controller expands the macro or lookup in the query so that the resulting in-line query includes the corresponding expressions rather than the referenced macro or lookup. The in-line query may thereby provide a fuller representation of the logic of the exported rule for subsequent translation from the source query language to the target query language.

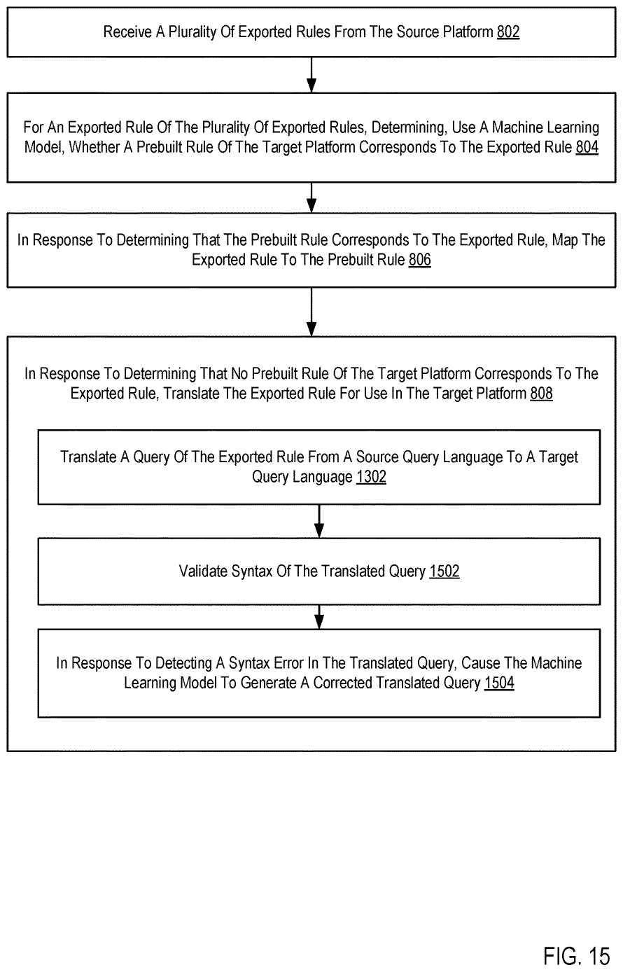

For further explanation, FIG. 15 sets forth a flowchart of another example method of migrating security detection rules from a source platform to a target platform in accordance with the present disclosure. The method of FIG. 15 is similar to the method of FIG. 13 in that the method of FIG. 15 includes all of the elements of FIG. 13.

In the method of FIG. 15, translating 808 the exported rule comprises validating 1502 syntax of the translated query. Validating 1502 syntax of the translated query may be carried out by evaluating the translated query to determine whether the translated query conforms to syntax of the target query language. In some examples, the migration controller checks the translated query after translation of the query from the source query language to the target query language. If a syntax error is detected, the translated query may be provided for correction, as previously described. In this way, the system verifies that the translated query is syntactically valid for use in the target platform.

In addition, translating 808 the exported rule comprises in response to detecting a syntax error in the translated query, causing 1504 the machine learning model to generate a corrected translated query. Causing 1504 the machine learning model to generate a corrected translated query may be carried out by providing the machine learning model with the translated query after detecting a syntax error in the translated query. In some examples, the migration controller prompts the machine learning model to correct the syntax error and regenerate the translated query in the target query language. The corrected translated query may then be used in place of the translated query that included the syntax error.

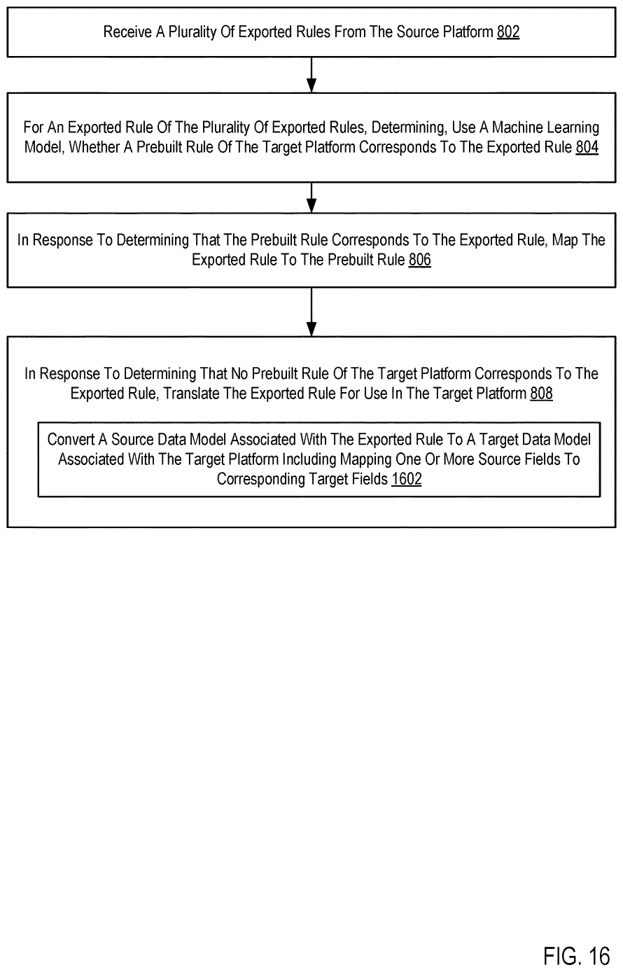

For further explanation, FIG. 16 sets forth a flowchart of another example method of migrating security detection rules from a source platform to a target platform in accordance with the present disclosure. The method of FIG. 16 is similar to the method of FIG. 8 in that the method of FIG. 16 includes all of the elements of FIG. 8.

In the method of FIG. 16, translating 808 the exported rule comprises converting 1602 a source data model associated with the exported rule to a target data model associated with the target platform including mapping one or more source fields to corresponding target fields. Converting 1602 a source data model associated with the exported rule to a target data model associated with the target platform including mapping one or more source fields to corresponding target fields may be carried out by using the machine learning model to map fields, categories, or other data elements referenced by the exported rule from the source data model to corresponding fields, categories, or other data elements of the target data model. In some examples, the migration controller maps one or more source fields referenced in the query of the exported rule to corresponding target fields for use in the translated rule. The converted target data model may then be used with the translated query for installation and use in the target platform.

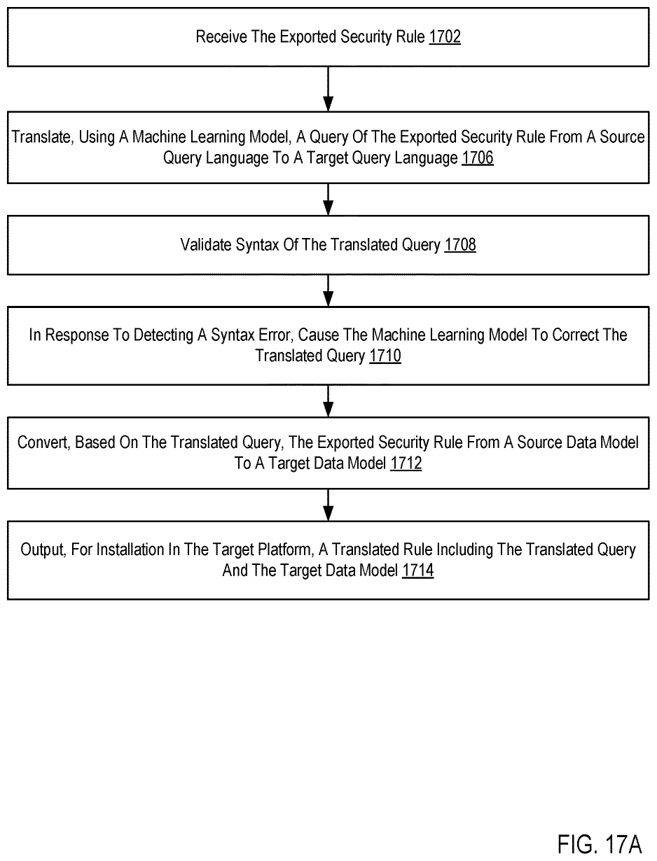

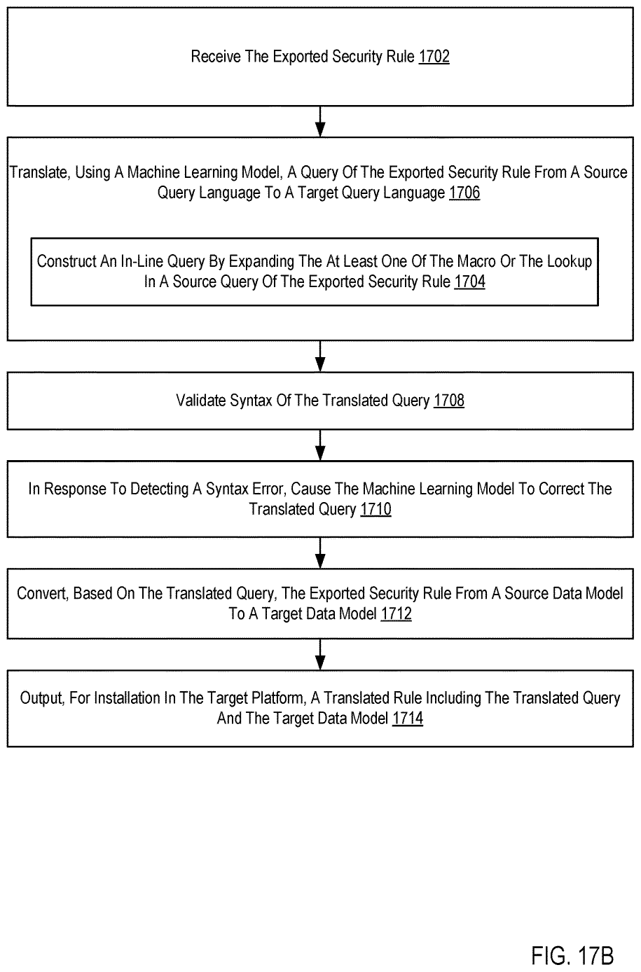

For further explanation, FIG. 17A sets forth a flowchart of an example method of translating an exported security rule from a source platform for use in a target platform in accordance with the present disclosure. In some examples, the method of FIG. 17A may be carried out by a migration controller configured to receive an exported security rule from a source platform for translation for use in a target platform.

The method of FIG. 17A includes receiving 1702 the exported security rule. Receiving 1702 the exported security rule may be carried out by receiving, from the source platform, an exported rule with or without any exported custom elements referenced by the rule. In some examples, the exported custom elements may include macros, lookups, or both, that are referenced in a query of the exported security rule. The migration controller may receive the exported security rule and any exported custom elements through a user upload of exported data from the source platform.

In addition, the method of FIG. 17A includes translating 1706, using a machine learning model, a query of the exported security rule from a source query language to a target query language. Translating 1706, using a machine learning model, a query of the exported security rule from a source query language to a target query language may be carried out by providing the query to the machine learning model and causing the machine learning model to generate a translated query in the target query language. In some examples, the migration controller supplies the query, which optionally includes expanded macros or lookups, so that the machine learning model translates the fuller logic of the exported security rule. The translated query is generated for use in the target platform in place of the source query language query of the exported security rule.

The method of FIG. 17A includes validating 1708 syntax of the translated query. Validating 1708 syntax of the translated query may be carried out by evaluating the translated query to determine whether the translated query conforms to syntax of the target query language. In some examples, the migration controller checks the translated query after translation of the in-line query from the source query language to the target query language. If a syntax error is detected, the translated query may be provided for correction, as previously described.

In addition, the method of FIG. 17A includes in response to detecting a syntax error, causing 1710 the machine learning model to correct the translated query. In response to detecting a syntax error, causing 1710 the machine learning model to correct the translated query may be carried out by providing the translated query to the machine learning model after detecting the syntax error in the translated query. In some examples, the migration controller prompts the machine learning model to fix the syntax error and generate a corrected translated query in the target query language. The corrected translated query may then be used in place of the translated query that included the syntax error.

The method of FIG. 17A includes converting 1712, based on the translated query, the exported security rule from a source data model to a target data model. Converting 1712, based on the translated query, the exported security rule from a source data model to a target data model may be carried out by using the translated query as a basis for mapping fields, categories, or other data elements referenced by the exported security rule from the source data model to corresponding fields, categories, or other data elements of the target data model. In some examples, the migration controller maps one or more source fields referenced in the exported security rule to corresponding target fields for use with the translated query in the target platform. The converted target data model may thereby align the translated query with the data structures used by the target platform.

The method of FIG. 17A also includes outputting 1714, for installation in the target platform, a translated rule including the translated query and the target data model. Outputting 1714, for installation in the target platform, a translated rule including the translated query and the target data model may be carried out by generating a translated rule that includes the translated query together with the target data model resulting from conversion of the exported security rule. In some examples, the migration controller outputs the translated rule as a rule ready for installation or deployment in the target platform. The translated rule may thereby be configured for use with the target platform in place of the exported security rule from the source platform.

In view of the foregoing, it will be appreciated that the method of FIG. 17A improves translation of an exported security rule from a source platform for use in a target platform by expanding referenced custom elements, translating a source query to a target query language, validating and correcting syntax of the translated query, and converting the exported security rule from a source data model to a target data model. By automating these operations, the method reduces manual effort otherwise required to interpret custom query logic, rewrite queries for the target platform, and align source data fields with corresponding target data fields. The method thereby increases the efficiency and consistency of translating exported security rules for installation in the target platform. In this way, the method of FIG. 17A supports more rapid and reliable deployment of translated security rules in the target platform.

For further explanation, FIG. 17B sets forth a flowchart of another example method of translating an exported security rule from a source platform for use in a target platform in accordance with the present disclosure. The method of FIG. 17B is similar to the method of FIG. 17A in that the method of FIG. 17B includes all of the elements of FIG. 17A.

In addition, the method of FIG. 17B includes constructing 1704 an in-line query by expanding, in the query, at least one macro or lookup referenced by the query. Constructing 1704 an in-line query by expanding, in the query, at least one macro or lookup referenced by the query may be carried out by identifying the macro or lookup referenced in the source query and obtaining a corresponding definition of the macro or lookup from the exported custom elements received with the exported security rule. In some examples, the migration controller expands the macro or lookup in the source query so that the resulting in-line query includes the corresponding expressions rather than the referenced macro or lookup. The in-line query may thereby provide a fuller representation of the logic of the exported security rule for subsequent translation from the source query language to the target query language.

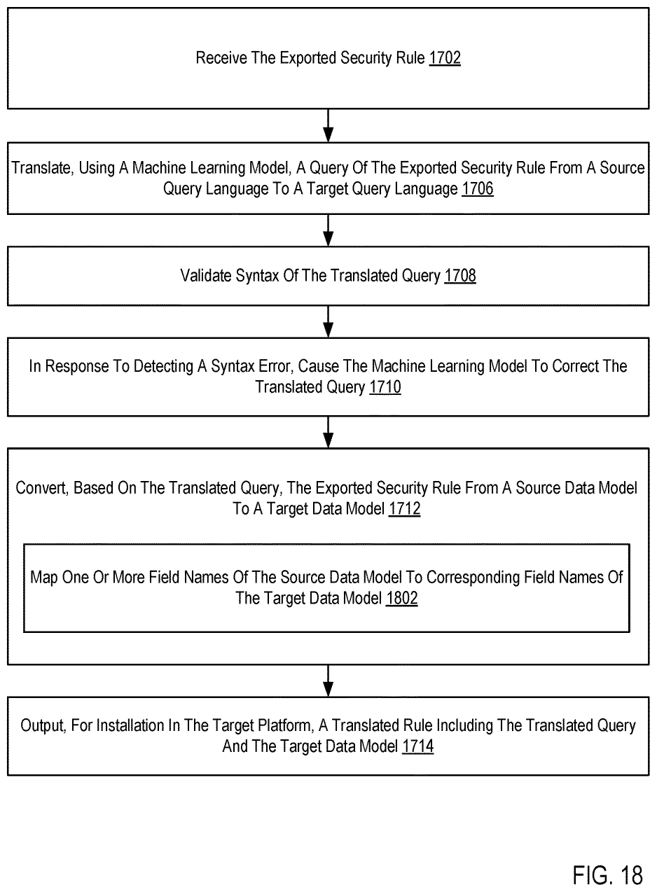

For further explanation, FIG. 18 sets forth a flowchart of another example method of translating an exported security rule from a source platform for use in a target platform in accordance with the present disclosure. The method of FIG. 18 is similar to the method of FIG. 17A in that the method of FIG. 18 includes all of the elements of FIG. 17A.

In the method of FIG. 18, converting 1712 the exported security rule from the source data model to the target data model comprises mapping 1802 one or more field names of the source data model to corresponding field names of the target data model. Mapping 1802 one or more field names of the source data model to corresponding field names of the target data model may be carried out by identifying field names referenced by the exported security rule in the source data model and determining corresponding field names in the target data model. In some examples, the migration controller uses the machine learning model to map source field names to target field names for use in the translated rule. The mapped field names may thereby align data referenced by the exported security rule with fields used by the target platform.

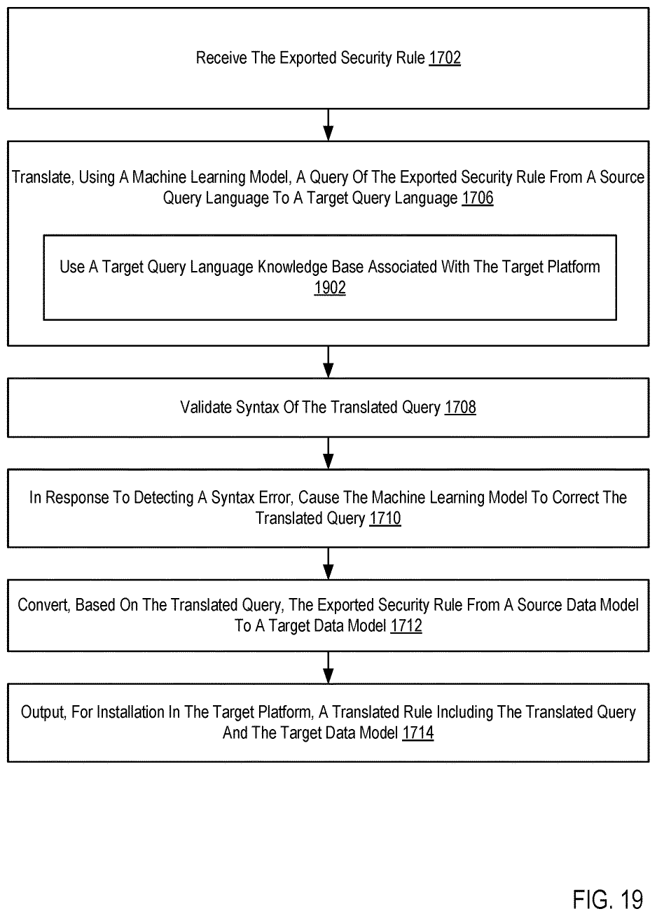

For further explanation, FIG. 19 sets forth a flowchart of another example method of translating an exported security rule from a source platform for use in a target platform in accordance with the present disclosure. The method of FIG. 19 is similar to the method of FIG. 17A in that the method of FIG. 19 includes all of the elements of FIG. 17A.

In the method of FIG. 19, translating 1706 the query comprises using 1902 a target query language knowledge base associated with the target platform. Using 1902 a target query language knowledge base associated with the target platform may be carried out by supplying, to the machine learning model, information from a knowledge base that conveys syntax or semantics of the target query language. In some examples, the migration controller uses the target query language knowledge base to augment operation of the machine learning model during translation of the query from the source query language to the target query language. The target query language knowledge base may thereby assist the machine learning model in generating a translated query that conforms to the target query language.

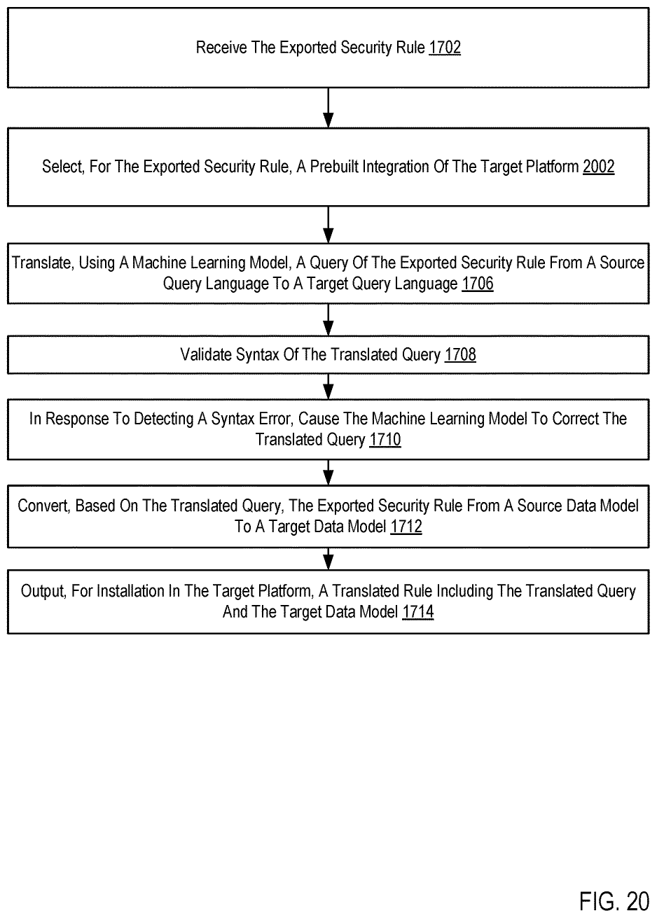

For further explanation, FIG. 20 sets forth a flowchart of another example method of translating an exported security rule from a source platform for use in a target platform in accordance with the present disclosure. The method of FIG. 20 is similar to the method of FIG. 17A in that the method of FIG. 20 includes all of the elements of FIG. 17A.

However, the method of FIG. 20 includes selecting 2002, for the exported security rule, a prebuilt integration of the target platform. Selecting 2002, for the exported security rule, a prebuilt integration of the target platform may be carried out by determining whether a prebuilt integration of the target platform corresponds to the exported security rule. In some examples, the migration controller identifies the prebuilt integration based on information in the exported security rule, such as a query of the exported security rule, as previously described. The selected prebuilt integration may be used in translating the exported security rule for use in the target platform.

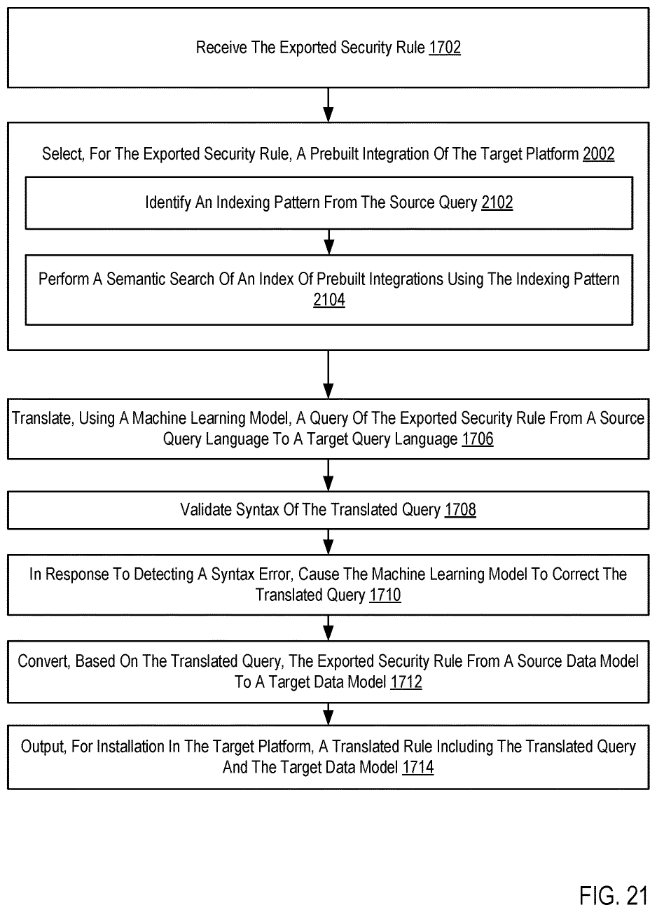

For further explanation, FIG. 21 sets forth a flowchart of another example method of translating an exported security rule from a source platform for use in a target platform in accordance with the present disclosure. The method of FIG. 21 is similar to the method of FIG. 20 in that the method of FIG. 21 includes all of the elements of FIG. 17A.

In the method of FIG. 21 selecting 2002 the prebuilt integration comprises identifying 2102 an indexing pattern from the source query. Identifying 2102 an indexing pattern from the source query may be carried out by examining the source query of the exported security rule to determine an indexing pattern referenced by the source query. In some examples, the migration controller identifies the indexing pattern from the source query after constructing an in-line query for the exported security rule. The identified indexing pattern may be used in searching prebuilt integrations of the target platform for a prebuilt integration corresponding to the exported security rule.

In addition, selecting 2002 the prebuilt integration comprises performing 2104 a semantic search of an index of prebuilt integrations using the indexing pattern. Performing 2104 a semantic search of an index of prebuilt integrations using the indexing pattern may be carried out by searching an index of prebuilt integrations of the target platform based on the indexing pattern identified from the source query. In some examples, the migration controller uses the indexing pattern to obtain search results identifying one or more prebuilt integrations that are potentially relevant to the exported security rule. The search results may then be used in selecting a prebuilt integration of the target platform for the exported security rule, as previously described.

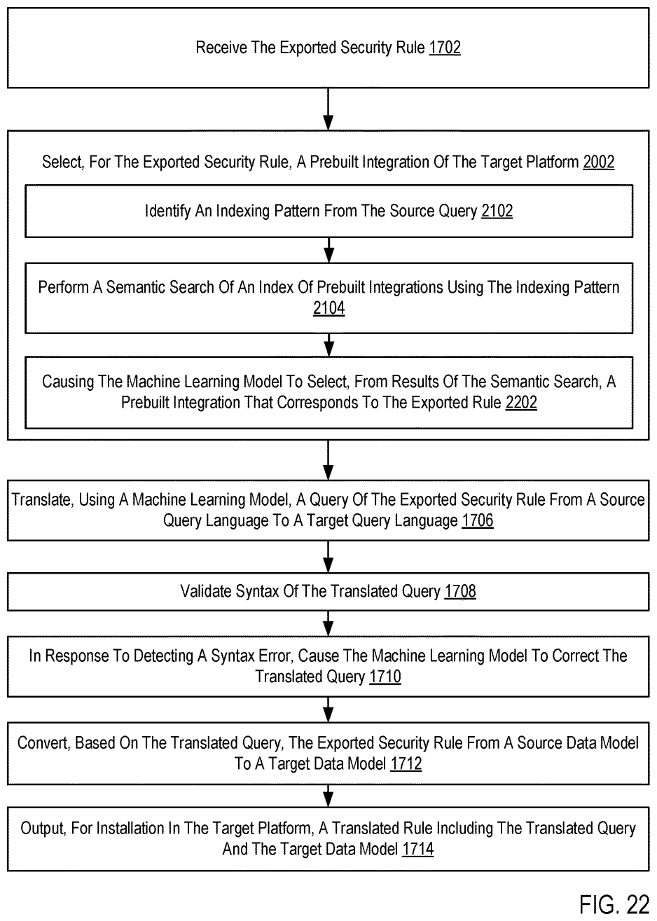

For further explanation, FIG. 22 sets forth a flowchart of another example method of translating an exported security rule from a source platform for use in a target platform in accordance with the present disclosure. The method of FIG. 22 is similar to the method of FIG. 20 in that the method of FIG. 22 includes all of the elements of FIG. 20.

In the method of FIG. 22, selecting 2002 the prebuilt integration further comprises causing 2202 the machine learning model to select, from results of the semantic search, a prebuilt integration that corresponds to the exported rule. Causing 2202 the machine learning model to select, from results of the semantic search, a prebuilt integration that corresponds to the exported rule may be carried out by providing the machine learning model with the results of the semantic search of the index of prebuilt integrations together with information from the exported rule. In some examples, the machine learning model evaluates the exported rule relative to the prebuilt integrations identified in the search results and selects a prebuilt integration that corresponds to the exported rule. If the machine learning model does not identify a corresponding prebuilt integration from the search results, the system may determine that the exported rule lacks a corresponding integration in the target platform.

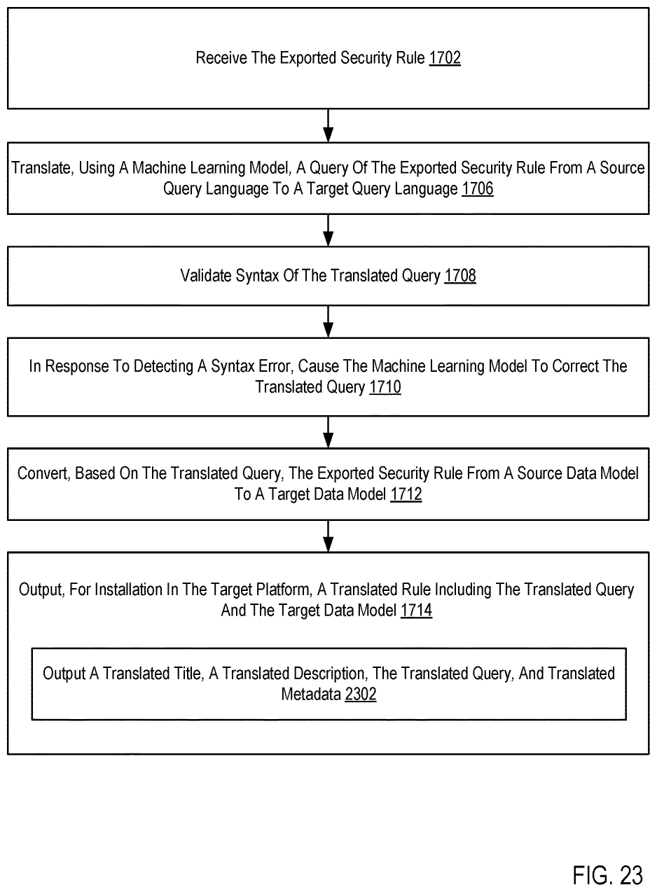

For further explanation, FIG. 23 sets forth a flowchart of another example method of translating an exported security rule from a source platform for use in a target platform in accordance with the present disclosure. The method of FIG. 23 is similar to the method of FIG. 17A in that the method of FIG. 23 includes all of the elements of FIG. 17A.

In the method of FIG. 23, outputting 1714 the translated rule comprises outputting 2302 a translated title, a translated description, the translated query, and translated metadata. Outputting 2302 a translated title, a translated description, the translated query, and translated metadata may be carried out by generating, from the exported security rule and the translated query, translated rule information for use in the target platform. In some examples, the migration controller outputs a translated title, a translated description, the translated query, and translated metadata as components of a translated rule prepared for installation in the target platform. The translated title, description, query, and metadata may thereby reflect the exported security rule in a form compatible with the target platform.

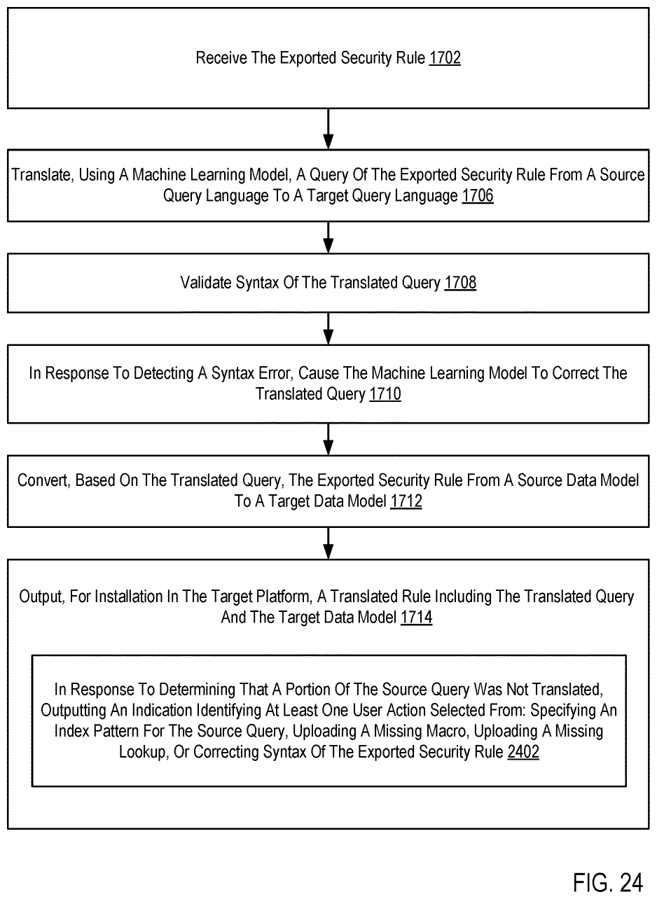

For further explanation, FIG. 24 sets forth a flowchart of another example method of translating an exported security rule from a source platform for use in a target platform in accordance with the present disclosure. The method of FIG. 24 is similar to the method of FIG. 17A in that the method of FIG. 24 includes all of the elements of FIG. 17A.

In the method of FIG. 24, outputting 1714 the translated rule comprises in response to determining that a portion of the source query was not translated, outputting 2402 an indication identifying at least one user action selected from: specifying an index pattern for the source query, uploading a missing macro, uploading a missing lookup, or correcting syntax of the exported security rule. In response to determining that a portion of the source query was not translated, outputting 2402 an indication identifying at least one user action selected from specifying an index pattern for the source query, uploading a missing macro, uploading a missing lookup, or correcting syntax of the exported security rule may be carried out by determining that translation of the source query is incomplete and generating an indication of one or more actions for addressing the untranslated portion. In some examples, the migration controller outputs the indication with the translated rule or migration results to inform a user of an action that may assist completion of translation of the exported security rule. The indicated user action may include specifying an index pattern for the source query, uploading a missing macro, uploading a missing lookup, or correcting syntax of the exported security rule.

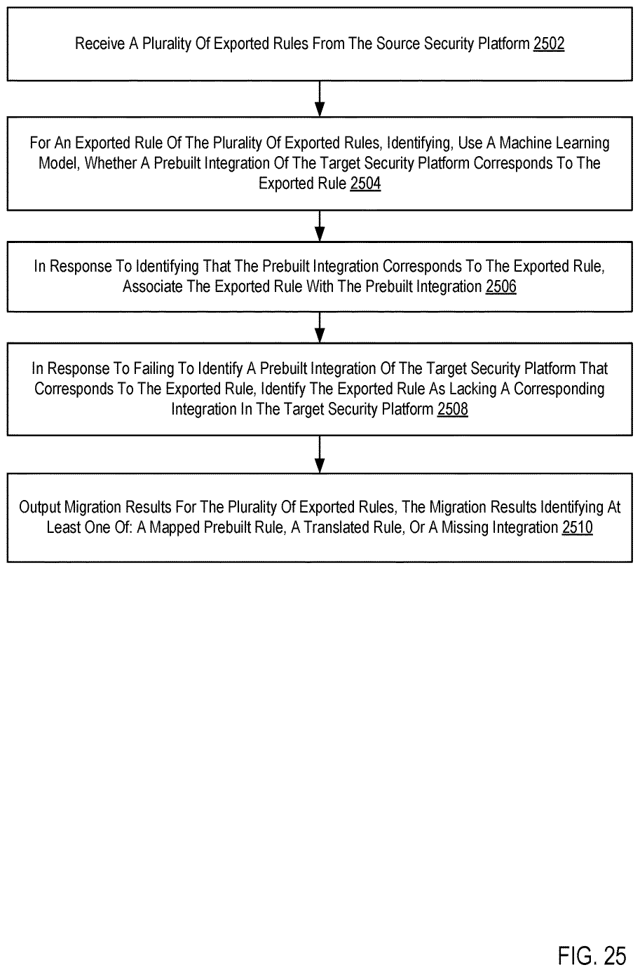

For further explanation, FIG. 25 sets forth a flowchart of an example method of onboarding data for migration from a source security platform to a target security platform in accordance with the present disclosure. In some examples, the method of FIG. 25 may be carried out by a migration controller configured to receive a plurality of exported rules from the source security platform and evaluate, for one or more of the exported rules, whether a prebuilt integration of the target security platform corresponds to the exported rule.

The method of FIG. 25 includes receiving 2502 a plurality of exported rules from the source security platform. Receiving 2502 a plurality of exported rules from the source security platform may be carried out by receiving, from the source security platform, exported data that includes multiple exported rules. In some examples, a migration controller receives the plurality of exported rules through a user upload of exported data from the source security platform. The migration controller may parse the exported data to identify the individual exported rules for subsequent processing.

The method of FIG. 25 includes for an exported rule of the plurality of exported rules, identifying 2504, using a machine learning model, whether a prebuilt integration of the target security platform corresponds to the exported rule. For an exported rule of the plurality of exported rules, identifying 2504, using a machine learning model, whether a prebuilt integration of the target security platform corresponds to the exported rule may be carried out by providing the machine learning model with information from the exported rule and using the machine learning model to evaluate whether a prebuilt integration of the target security platform corresponds to the exported rule. In some examples, the determination may be based on a query of the exported rule, as previously described with respect to identifying an indexing pattern and searching an index of prebuilt integrations. The machine learning model may identify a corresponding prebuilt integration or determine that no prebuilt integration of the target security platform corresponds to the exported rule.

In addition, the method of FIG. 25 includes in response to identifying that the prebuilt integration corresponds to the exported rule, associating 2506 the exported rule with the prebuilt integration. In response to identifying that the prebuilt integration corresponds to the exported rule, associating 2506 the exported rule with the prebuilt integration may be carried out by creating an association between the exported rule and the corresponding prebuilt integration in a data structure maintained by the migration controller. In some examples, the association may be included in migration results or other configuration information used for onboarding the exported rule to the target security platform. The association may indicate that the exported rule is to use the prebuilt integration in the target security platform.

The method of FIG. 25 includes in response to failing to identify a prebuilt integration of the target security platform that corresponds to the exported rule, identifying 2508 the exported rule as lacking a corresponding integration in the target security platform. In response to failing to identify a prebuilt integration of the target security platform that corresponds to the exported rule, identifying 2508 the exported rule as lacking a corresponding integration in the target security platform may be carried out by determining, based on evaluation of the exported rule and any candidate prebuilt integrations, that no prebuilt integration of the target security platform corresponds to the exported rule. In some examples, the migration controller marks the exported rule in migration results or other onboarding information as missing a corresponding integration in the target security platform. The identification may indicate that the exported rule is not presently associated with a prebuilt integration of the target security platform.

The method of FIG. 25 includes outputting 2510 migration results for the plurality of exported rules, the migration results identifying at least one of: a mapped prebuilt rule, a translated rule, or a missing integration. Outputting 2510 migration results for the plurality of exported rules, the migration results identifying at least one of a mapped prebuilt rule, a translated rule, or a missing integration, may be carried out by generating results that indicate, for one or more of the exported rules, an outcome of processing of the exported rule for migration to the target security platform. In some examples, the migration controller outputs migration results identifying whether an exported rule was mapped to a prebuilt rule, translated for use in the target security platform, or identified as lacking a corresponding integration in the target security platform. The migration results may be provided to a user or stored for use in onboarding and migration of the exported rules to the target security platform.

In view of the foregoing, it will be appreciated that the method of FIG. 25 improves operation of a target security platform during migration from a source security platform by automatically determining whether exported rules correspond to prebuilt integrations of the target security platform and by identifying when corresponding prebuilt integrations are unavailable. By associating exported rules with corresponding prebuilt integrations where available, and by indicating missing integrations where corresponding prebuilt integrations are unavailable, the method enables the target security platform to onboard data needed for execution of migrated security content using appropriate target-platform integrations. The method thereby reduces incompatibility between source-platform rule content and target-platform data ingestion requirements and improves the efficiency, consistency, reliability, and speed of preparing exported rules for migration and deployment in the target security platform.

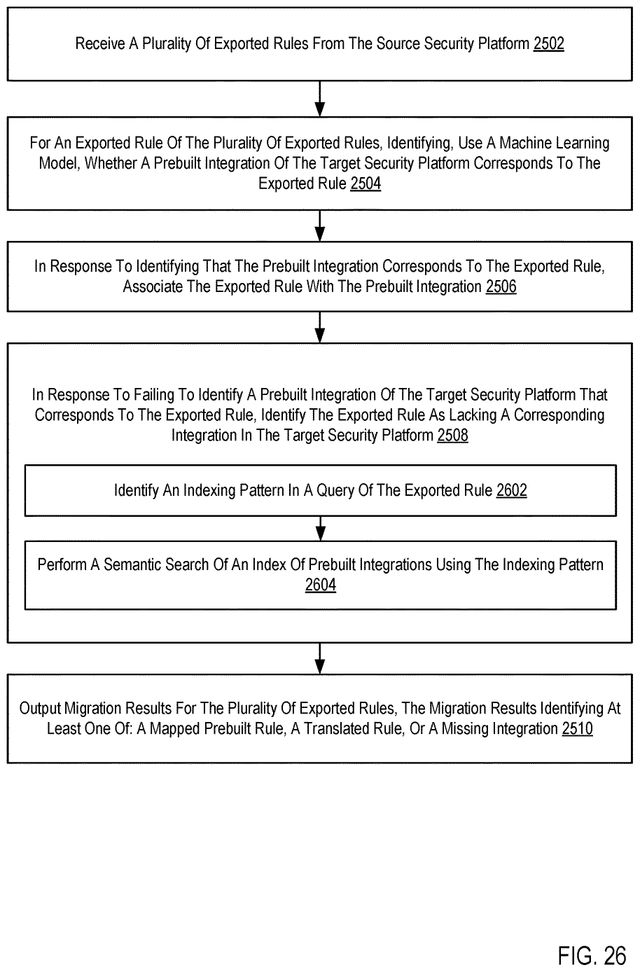

For further explanation, FIG. 26 sets forth a flowchart of another example method of translating an exported security rule from a source platform for use in a target platform in accordance with the present disclosure. The method of FIG. 26 is similar to the method of FIG. 25 in that the method of FIG. 26 includes all of the elements of FIG. 25.

In the method of FIG. 26, identifying 2508 whether the prebuilt integration of the target security platform corresponds to the exported rule comprises identifying 2602 an indexing pattern in a query of the exported rule. Identifying 2602 an indexing pattern in a query of the exported rule may be carried out by examining the query of the exported rule to determine an indexing pattern referenced by the query. In some examples, the migration controller identifies the indexing pattern from the query of the exported rule for use in searching prebuilt integrations of the target security platform. The identified indexing pattern may be used to locate prebuilt integrations that are potentially relevant to the exported rule, as previously described.

In addition, identifying 2508 whether the prebuilt integration of the target security platform corresponds to the exported rule includes performing 2604 a semantic search of an index of prebuilt integrations using the indexing pattern. Performing 2604 a semantic search of an index of prebuilt integrations using the indexing pattern may be carried out by searching an index of prebuilt integrations of the target security platform based on the indexing pattern identified from the query of the exported rule. In some examples, the migration controller uses the indexing pattern to obtain search results identifying one or more prebuilt integrations that are potentially relevant to the exported rule. The search results may then be used in determining whether a prebuilt integration of the target security platform corresponds to the exported rule, as previously described.

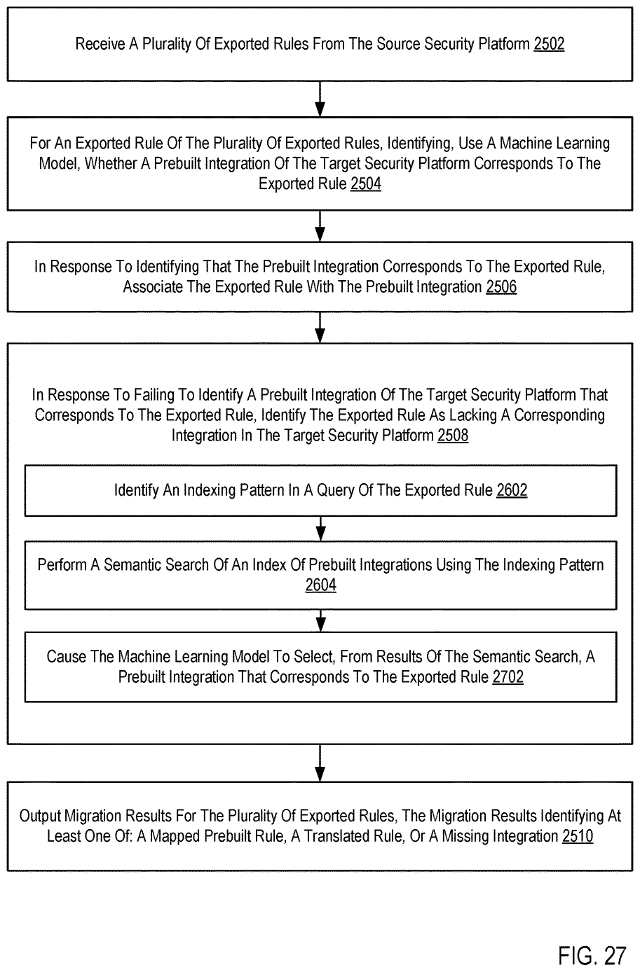

For further explanation, FIG. 27 sets forth a flowchart of another example method of translating an exported security rule from a source platform for use in a target platform in accordance with the present disclosure. The method of FIG. 27 is similar to the method of FIG. 26 in that the method of FIG. 27 includes all of the elements of FIG. 26.

In the method of FIG. 27, identifying 2602 whether the prebuilt integration of the target security platform corresponds to the exported rule further comprises causing 2702 the machine learning model to select, from results of the semantic search, a prebuilt integration that corresponds to the exported rule. Causing 2702 the machine learning model to select, from results of the semantic search, a prebuilt integration that corresponds to the exported rule may be carried out by providing the machine learning model with the results of the semantic search of the index of prebuilt integrations together with information from the exported rule. In some examples, the machine learning model evaluates the exported rule relative to the prebuilt integrations identified in the search results and selects a prebuilt integration that corresponds to the exported rule. If the machine learning model does not identify a corresponding prebuilt integration from the search results, the system may determine that the exported rule lacks a corresponding integration in the target security platform.

Exemplary embodiments of the present invention are described largely in the context of a fully functional computer system for orchestrating a multi-tenant search and analytics engine and datastore. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. People who are skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Hardware logic, including programmable logic for use with a programmable logic device (PLD) implementing all or part of the functionality previously described herein, may be designed using traditional manual methods or may be designed, captured, simulated, or documented electronically using various tools, such as Computer Aided Design (CAD) programs, a hardware description language (e.g., VHDL or Verilog), or a PLD programming language. Hardware logic may also be generated by a non-transitory computer readable medium storing instructions that, when executed by a processor, manage parameters of a semiconductor component, a cell, a library of components, or a library of cells in electronic design automation (EDA) software to generate a manufacturable design for an integrated circuit. In implementation, the various components described herein might be implemented as discrete components or the functions and features described can be shared in part or in total among one or more components. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A computer-implemented method of migrating security detection rules from a source platform to a target platform, the method comprising:
receiving a plurality of exported rules from the source platform;
for an exported rule of the plurality of exported rules, determining, using a machine learning model, whether a prebuilt rule of the target platform corresponds to the exported rule;
in response to determining that the prebuilt rule corresponds to the exported rule, mapping the exported rule to the prebuilt rule; and
in response to determining that no prebuilt rule of the target platform corresponds to the exported rule, translating the exported rule for use in the target platform.

2. The computer-implemented method of claim 1, wherein determining whether the prebuilt rule corresponds to the exported rule further comprises:
extracting one or more keywords from the exported rule; and
performing a semantic search of an index of prebuilt rules using the one or more keywords to identify a plurality of candidate prebuilt rules.

3. The computer-implemented method of claim 2, wherein determining whether the prebuilt rule of the target platform corresponds to the exported rule comprises:
providing the plurality of candidate prebuilt rules as context to the machine learning model; and
causing the machine learning model to select, from the plurality of candidate prebuilt rules, the prebuilt rule that corresponds to the exported rule.

4. The computer-implemented method of claim 3, wherein determining whether the prebuilt rule of the target platform corresponds to the exported rule further comprises using a title, a description, and metadata extracted from the rule, as contextual information for retrieval augmented generation with the machine learning model.

5. The computer-implemented method of claim 1, wherein translating the exported rule comprises:
identifying an indexing pattern in a query of the exported rule;
performing a semantic search of an index of prebuilt integrations using the indexing pattern to identify a plurality of candidate prebuilt integrations; and
causing the machine learning model to select, from the plurality of candidate prebuilt integrations, a prebuilt integration of the target platform that corresponds to the exported rule.

6. The computer-implemented method of claim 1, wherein translating the exported rule comprises translating a query of the exported rule from a source query language to a target query language.

7. The computer-implemented method of claim 6, wherein translating the exported rule comprises prior to translating the query, constructing an in-line query by expanding, in the query, at least one macro or lookup referenced by the query.

8. The computer-implemented method of claim 6, wherein translating the exported rule further comprises:
validating syntax of the translated query; and
in response to detecting a syntax error in the translated query, causing the machine learning model to generate a corrected translated query.

9. The computer-implemented method of claim 1, wherein translating the exported rule comprises converting a source data model associated with the exported rule to a target data model associated with the target platform including mapping one or more source fields to corresponding target fields.

10. A computer-implemented method of translating an exported security rule from a source platform for use in a target platform, the method comprising:
receiving the exported security rule;
translating, using a machine learning model, a query of the exported security rule from a source query language to a target query language;
validating syntax of the translated query;
in response to detecting a syntax error, causing the machine learning model to correct the translated query;
converting, based on the translated query, the exported security rule from a source data model to a target data model; and
outputting, for installation in the target platform, a translated rule including the translated query and the target data model.

11. The computer-implemented method of claim 10, wherein converting the exported security rule from the source data model to the target data model comprises mapping one or more field names of the source data model to corresponding field names of the target data model.

12. The computer-implemented method of claim 10, wherein translating the query comprises:
constructing an in-line query by expanding, in the query, at least one macro or lookup referenced by the query.

13. The computer-implemented method of claim 10, wherein translating the query comprises:
using a target query language knowledge base associated with the target platform.

14. The computer-implemented method of claim 10 further comprising selecting, for the exported security rule, a prebuilt integration of the target platform.

15. The computer-implemented method of claim 14, wherein selecting the prebuilt integration comprises:
identifying an indexing pattern from the source query; and
performing a semantic search of an index of prebuilt integrations using the indexing pattern.

16. The computer-implemented method of claim 14, wherein selecting the prebuilt integration further comprises:
causing the machine learning model to select, from results of the semantic search, a prebuilt integration that corresponds to the exported rule.

17. The computer-implemented method of claim 10, wherein outputting the translated rule comprises outputting a translated title, a translated description, the translated query, and translated metadata.

18. The computer-implemented method of claim 10, wherein outputting the translated rule comprises in response to determining that a portion of the source query was not translated, outputting an indication identifying at least one user action selected from: specifying an index pattern for the source query, uploading a missing macro, uploading a missing lookup, or correcting syntax of the exported security rule.

19. A computer-implemented method of onboarding data for migration from a source security platform to a target security platform, the method comprising:
receiving a plurality of exported rules from the source security platform;
for an exported rule of the plurality of exported rules, identifying, using a machine learning model, whether a prebuilt integration of the target security platform corresponds to the exported rule;
in response to identifying that the prebuilt integration corresponds to the exported rule, associating the exported rule with the prebuilt integration;
in response to failing to identify a prebuilt integration of the target security platform that corresponds to the exported rule, identifying the exported rule as lacking a corresponding integration in the target security platform; and
outputting migration results for the plurality of exported rules, the migration results identifying at least one of: a mapped prebuilt rule, a translated rule, or a missing integration.

20. The computer-implemented method of claim 19, wherein identifying whether the prebuilt integration of the target security platform corresponds to the exported rule comprises:
identifying an indexing pattern in a query of the exported rule; and
performing a semantic search of an index of prebuilt integrations using the indexing pattern; and
causing the machine learning model to select, from results of the semantic search, a prebuilt integration that corresponds to the exported rule.
